(19) United States
(12) Patent Application Publication
(10) Pub. No.: US 2024/0396678 A1
(43) Pub. Date: Nov. 28, 2024

(54) SIGNALING SUPPORT FOR MULTIPLE CODING SCHEMES TO A SINGLE USER DEVICE

(71) Applicant: QUALCOMM Incorporated, San Diego, CA (US)

(72) Inventors: Lin YANG, San Diego, CA (US); Jialing Li CHEN, San Diego, CA (US); Bin TIAN, San Diego, CA (US); Vamsi Krishna AMALLADINNE, Fullerton, CA (US); Sameer VERMANI, San Diego, CA (US)

(21) Appl. No.: 18/321,624

(22) Filed: May 22, 2023

(51) Int. Cl. H04L 5/00; H04L 1/00

(52) U.S. Cl. CPC H04L 5/0023; H04L 1/0003; H04L 1/0009; H04L 5/0048

(57) ABSTRACT

Methods, systems, and devices for wireless communications are described. A first device may transmit control signaling to a second device. The control signaling may indicate a set of different modulation and coding schemes (MCSs) to be applied to at least one of a set of spatial streams or a set of resource units (RUS), where the control signaling may indicate that a respective MCS to be applied to a respective spatial stream or to a respective RU. The first device may transmit, one or more first bits of a first service data unit to the second device via a first spatial stream of or via a first RU using a first MCS and transmit one or more second bits, of the first service data unit or of a second service data unit via a second spatial stream or via a second RU using a second MCS.

### BACKGROUND

The following relates to wireless communications, including signaling support for multiple coding schemes to a single user device.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

### SUMMARY

A method for wireless communications at a transmitter wireless device is described. The method may include transmitting control signaling to a first receiver wireless device, the control signaling indicating a set of multiple different modulation and coding schemes (MCSs) to be applied to at least one of a set of multiple spatial streams or a set of multiple resource units (RUS), and where the control signaling indicates that a respective MCS of the set of multiple different MCSs is being applied to a respective spatial stream of the set of multiple spatial streams or to a respective RU of the set of multiple RUs, transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs, and transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

An apparatus for wireless communications at a transmitter wireless device is described. The apparatus may include at least one memory and at least one processor coupled to the at least one memory, the at least one processor configured to transmit control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs, transmit, in accordance with the control signaling, one or more first bits of a first service data unit to the first receiver wireless device via a first spatial stream of the set of multiple spatial streams or via a first RU of the set of multiple RUs using a first MCS of the set of multiple different MCSs, and transmit, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

Another apparatus for wireless communications at a transmitter wireless device is described. The apparatus may include means for transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs, means for transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs, and means for transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

A non-transitory computer-readable medium storing code for wireless communications at a transmitter wireless device is described. The code may include instructions executable by at least one processor to transmit control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs, transmit, in accordance with the control signaling, one or more first bits of a first service data unit to the first receiver wireless device via a first spatial stream of the set of multiple spatial streams or via a first RU of the set of multiple RUs using a first MCS of the set of multiple different MCSs, and transmit, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

In some examples of the method, apparatuses, and non-transitory computer-readable medium described herein, the control signaling includes a set of multiple user information fields (UIFs), each of the set of multiple UIFs indicates a respective MCS of the set of multiple different MCSs may be being applied to a respective spatial stream of the set of multiple spatial streams or a respective RU of the set of multiple RUs, and each of the set of multiple UIFs includes a user identification associated with the first receiver wireless device.

In some examples of the method, apparatuses, and non-transitory computer-readable medium described herein, the control signaling includes a single user specific field (USF) that indicates the first receiver wireless device, the single USF indicating each respective MCS of the set of multiple different MCSs may be being applied to a respective spatial stream of the set of multiple spatial streams or to a respective RU of the set of multiple RUS.

In some examples of the method, apparatuses, and non-transitory computer-readable medium described herein, the single USF includes a UIF including one or more bits, and a first bit value of the one or more bits indicates that the UIF includes a subfield indicating a respective MCS of the set of multiple different MCSs may be being applied to each respective spatial stream of the set of multiple spatial streams or each respective RU of the set of multiple RUs.

In some examples of the method, apparatuses, and non-transitory computer-readable medium described herein, a size of each of the respective groups of spatial streams or a size of each of the respective groups of RUs and a quantity of the respective groups of spatial streams or a quantity of the respective groups of RUs.

In some examples of the method, apparatuses, and non-transitory computer-readable medium described herein, the single USF may have a fixed size.

In some examples of the method, apparatuses, and non-transitory computer-readable medium described herein, each respective MCS corresponds to a respective spatial stream, each respective spatial stream may be ordered in accordance with a non-increasing order of a respective code rate associated with the corresponding respective MCS, the single USF indicates the first MCS for the first spatial stream of the set of multiple spatial streams and a respective differential value for each other spatial stream of the set of multiple spatial streams, each respective differential value indicates an MCS relative to an MCS associated with an adjacent stream, and the first MCS may be associated with a highest code rate or lowest code rate of the respective MCSs.

In some examples of the method, apparatuses, and non-transitory computer-readable medium described herein, each respective MCS corresponds to a respective spatial stream, each spatial stream of the set of multiple spatial streams may be grouped into one or more spatial streams subsets, and the single USF indicates a different MCS associated with each spatial stream subset of the one or more spatial stream subsets.

In some examples of the method, apparatuses, and non-transitory computer-readable medium described herein, the control signaling includes a common field and set of UIFs including the single USF and the method, apparatuses, and non-transitory computer-readable medium may include further operations, features, means, or instructions for encoding the common field and each UIF using a respective code block.

In some examples of the method, apparatuses, and non-transitory computer-readable medium described herein, the control signaling includes a set of UIFs including the single USF and the method, apparatuses, and non-transitory computer-readable medium may include further operations, features, means, or instructions for encoding respective subsets of the set of UIFs using respective code blocks based on a quantity of bits in each respective UIF satisfying a bit quantity threshold, where a given subset of the set of UIFs includes a quantity of bits less than or equal to a size of a corresponding code block.

In some examples of the method, apparatuses, and non-transitory computer-readable medium described herein, a bit size of the control signaling may be based on the control signaling including the indication of the respective MCS per spatial stream of the set of multiple spatial streams or per RU of the set of multiple RUs.

Some examples of the method, apparatuses, and non-transitory computer-readable medium described herein may further include operations, features, means, or instructions for encoding a set of bits of the first service data unit using a same code rate and mapping, via a stream parser, the one or more first bits to the first spatial stream and the one or more second bits to the second spatial stream, where a first quantity of bits in the one or more first bits may be proportional to a first modulation size of the first MCS, and a second quantity of bits in the one or more second bits may be proportional to a second modulation size of the second MCS.

Some examples of the method, apparatuses, and non-transitory computer-readable medium described herein may further include operations, features, means, or instructions for encoding, using a set of multiple encoders associated with the set of multiple spatial streams, a set of bits of the first service data unit, where the one or more first bits may be encoded using a first encoder of the set of multiple encoders associated with the first spatial stream, the one or more second bits may be encoded using a second encoder of the set of multiple encoders associated with the second spatial stream, a first quantity of bits in the one or more first bits may be proportional to a first modulation size and a first code rate of the first MCS, and a second quantity of bits in the one or more second bits may be proportional to a second modulation size and a second code rate of the second MCS.

In some examples of the method, apparatuses, and non-transitory computer-readable medium described herein, MCSs of the set of multiple different MCSs that may have a same code rate may be associated with a same encoder of the set of multiple encoders.

Some examples of the method, apparatuses, and non-transitory computer-readable medium described herein may further include operations, features, means, or instructions for encoding a set of bits of the first service data unit using a same code rate and mapping, via a RU parser, the one or more first bits to the first RU and the one or more second bits to the second RU, where a first quantity of bits in the one or more first bits may be proportional to a first modulation size of the first MCS and a first size of the first RU, the first RU associated with a first tone mapper, and a second quantity of bits in the one or more second bits may be proportional to a second modulation size of the second MCS a second size of the second RU, the second RU associated with a second tone mapper.

Some examples of the method, apparatuses, and non-transitory computer-readable medium described herein may further include operations, features, means, or instructions for encoding, using a set of multiple encoders associated with the set of multiple RUs, a set of bits of the first service data unit, where the one or more first bits may be encoded using a first encoder of the set of multiple encoders associated with the first RU, the first RU associated with a first tone mapper, the one or more second bits may be encoded using a second encoder of the set of multiple encoders associated with the second RU, the second RU associated with a second tone mapper, a first quantity of bits in the one or more first bits may be proportional to a first modulation size, a first code rate of the first MCS, and a first size of the first RU, and a second quantity of bits in the one or more second bits may be proportional to a second modulation size, a second code rate of the second MCS, and a second size of the second RU.

In some examples of the method, apparatuses, and non-transitory computer-readable medium described herein, the transmitter wireless device transmits the second service data unit in addition to the first service data unit and the method, apparatuses, and non-transitory computer-readable medium may include further operations, features, means, or instructions for encoding the first service data unit using a first encoder of a set of multiple encoders and the second service data unit using a second encoder of the set of multiple encoders, where each of the set of multiple encoders may be associated with a respective spatial stream of the set of multiple spatial streams and the respective MCS associated with the respective spatial stream.

In some examples of the method, apparatuses, and non-transitory computer-readable medium described herein, MCSs of the set of multiple different MCSs that may have a same code rate may be associated with a same encoder of the set of multiple encoders.

In some examples of the method, apparatuses, and non-transitory computer-readable medium described herein, the transmitter wireless device transmits the second service data unit in addition to the first service data unit and the method, apparatuses, and non-transitory computer-readable medium may include further operations, features, means, or instructions for encoding the first service data unit using a first encoder of a set of multiple encoders and the second service data unit using a second encoder of the set of multiple encoders, where each of the set of multiple encoders may be associated with a respective RU of the set of multiple RUs and the respective MCS associated with the respective RU, and each of respective RU may be associated with a respective tone mapper.

### BRIEF DESCRIPTION OF THE DRAWINGS

FIGS. 1 through 2 each show a respective example of a wireless communications system that supports signaling for multiple coding schemes to a single user device in accordance with aspects of the present disclosure.

FIG. 3 through 7 each show a respective example of a single physical layer convergence protocol (PLCP) service data unit (PSDU) encoding procedure that supports signaling for multiple coding schemes to a single user device in accordance with one or more aspects of the present disclosure.

FIG. 8 through 10 each show a respective example of a multi-PSDU encoding procedure that supports signaling for multiple coding schemes to a single user device in accordance with one or more aspects of the present disclosure.

FIG. 11 shows an example of a process flow that supports signaling for multiple coding schemes to a single user device in accordance with one or more aspects of the present disclosure.

FIGS. 12 and 13 show block diagrams of devices that support signaling support for multiple coding schemes to a single user device in accordance with one or more aspects of the present disclosure.

FIG. 14 shows a block diagram of a communications manager that supports signaling for multiple coding schemes to a single user device in accordance with one or more aspects of the present disclosure.

FIG. 15 shows a diagram of a system including a device that supports signaling for multiple coding schemes to a single user device in accordance with one or more aspects of the present disclosure.

FIGS. 16 and 17 show flowcharts illustrating methods that support signaling support for multiple coding schemes to a single user device in accordance with one or more aspects of the present disclosure.

### DETAILED DESCRIPTION

In some examples of wireless communications, a transmitter device may transmit data to a single user device in accordance with a modulation and coding scheme (MCS). A given MCS may be associated with a type of modulation (e.g., quadrature amplitude modulation (QAM), quadrature phase shift keying (QPSK), binary phase shift keying (BPSK), etc.) and a code rate (e.g., a ratio indicating a number of redundant bits included in a service data unit). In some cases, it may be advantageous for the transmitter device to transmit different portions of data using different spatial streams, or different resource units (RUS), or both. For example, the transmitter device may transmit a first portion of a first service data unit on a first spatial stream or first RU and transmit a second portion of the first service data unit on a second spatial stream or second RU. In some cases, however, different spatial streams or RUs may be associated with different levels of quality (e.g., a different signal to noise ratio (SNR)), and it may be advantageous to use different (e.g., unequal) MCSs for different spatial streams or RUs. However, without signaling that indicates unequal MCS across spatial streams or RUs to the single user device, the single user device may be unable to receive one or more service data units encoded using multiple unequal MCSs.

In some implementations of the present disclosure, a wireless communications system may support the use of unequal MCSs across multiple spatial streams, or RUs, or both. For example, the transmitter device may include in a physical (PHY) preamble an indication of a set of MCSs corresponding to a set of spatial streams, a set of RUs, or both. In some cases, the transmitter device may include indication of each unequal MCS using a respective user info field (UIF), where each UIF includes an identification of the single user device. In some other cases, the transmitter device may indicate each of the unequal MCSs in the corresponding spatial stream or RU in a single user specific field (USF).

The transmitter device may encode data in accordance with the MCSs indicated in the PHY preamble. For example, the transmitter device may first prepare a service data unit (e.g., a PHY layer convergence protocol (PLCP) service data unit (PSDU)) in a medium access control (MAC) layer. As such, the transmitter device may encode the PSDU in the PHY layer. In some cases, the transmitter device may encode the entire PSDU using a same code rate and then parse the encoded PSDU into portions, where each portion may correspond to a spatial stream or RU, where the size of each portion is proportional to the MCS used for a given spatial stream or RU. In some cases, the transmitter device may parse the uncoded PSDU into portions, where each portion corresponds to a respective encoder associated with a respective MCS.

Moreover, in scenarios in which the transmitter device may encode portions data across multiple spatial streams or RUs using unequal MCS, the transmitter device and single user device may benefit from a reduction in signal noise. For example, based on different spatial streams and RUs being associated with different levels of noise, applying respective MCSs to each spatial stream or RU may improve throughput on a per spatial stream or RU basis. Such use of respective MCSs may allow an increase in throughput for signal noise reeducation for each spatial stream or RU.

Aspects of the disclosure are initially described in the context of wireless communications systems. Aspects of the disclosure are further illustrated by single PSDU encoding procedures, multi-PSDU encoding procedures, and a process flow. Aspects of the disclosure are further illustrated by and described with reference to apparatus diagrams, system diagrams, and flowcharts that relate to signaling support for multiple coding schemes to a single user device

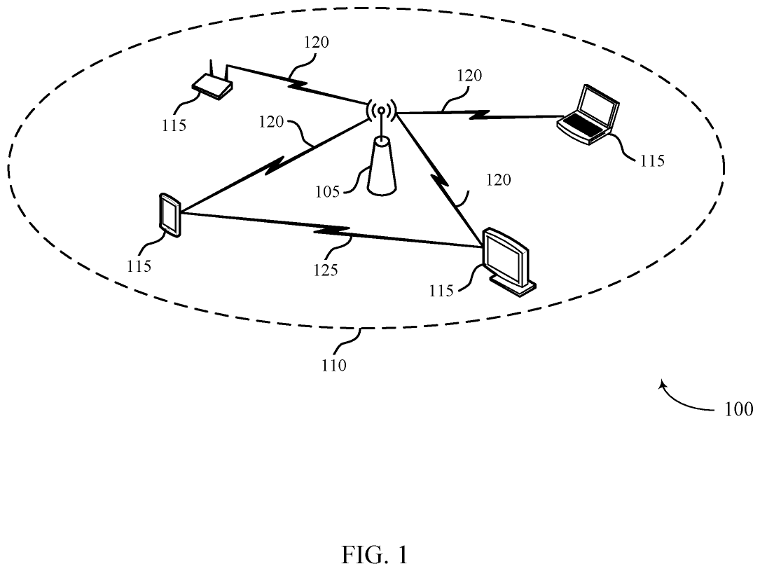

FIG. 1 shows a wireless communications system 100 (also known as a Wi-Fi network) configured in accordance with various aspects of the present disclosure. The wireless communications system 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a BSS or an ESS. The various STAs 115 in the network are able to communicate with one another through the AP 105. Also shown is a coverage area 110 of the AP 105, which may represent a BSA of the wireless communications system 100. An extended network station (not shown) associated with the wireless communications system 100 may be connected to a wired or wireless distribution system that may allow multiple APs 105 to be connected in an ESS.

In some implementations, wireless communications system 100 may support the use of unequal MCSs across multiple spatial streams or RUs. For example, an AP 105 serving as a transmitter device may include in a PHY preamble an indication of a set of MCSs corresponding to a set of spatial streams, a set of RUs, or both. In some cases, the transmitter device may include indication of each unequal MCS using a respective UIF, where each UIF includes an identification of the single user device. In some other cases, the transmitter device may indicate each of the unequal MCSs in the corresponding spatial stream or RU in a single USF.

The transmitter device may encode data in accordance with the MCSs indicated in the PHY preamble. For example, the transmitter device may first prepare a service data unit (e.g., a PSDU) in the MAC layer. As such, the transmitter device may encode the PSDU in the PHY layer. In some cases, the transmitter device may encode the entire PSDU using a same code rate and then parse the encoded PSDU into portions, where each portion may correspond to a spatial stream or RU, where the size of each portion is proportional to the MCS used for a given spatial stream or RU. In some cases, the transmitter device may parse the uncoded PSDU into portions, where each portion corresponds to a respective encoder associated with a respective MCS or code rate.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11 g, 802.11a, 802.11n, 802.11ac, 802.11ad, 802.11ah, 802.11ax, etc. In other implementations, peer-to-peer connections or ad hoc networks may be implemented within wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

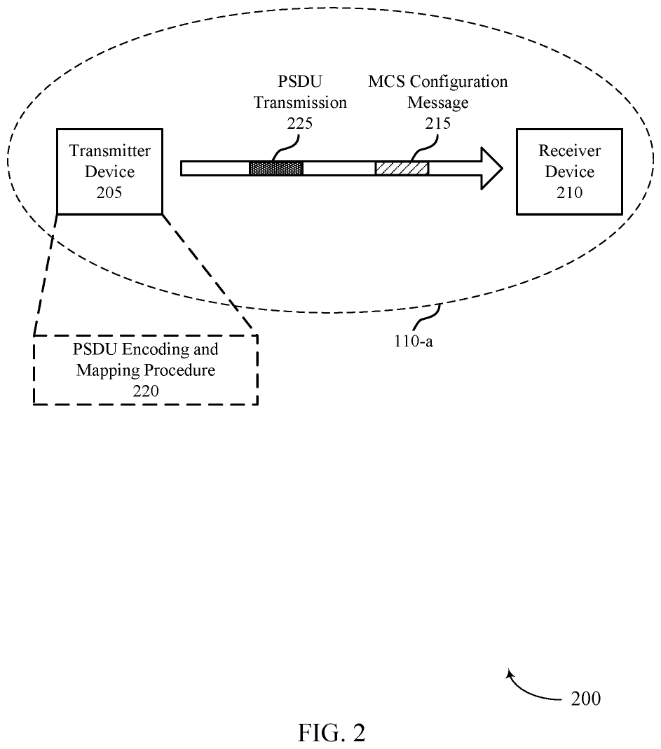

FIG. 2 shows an example of a wireless communications system 200 that supports signaling for multiple coding schemes to a single user device in accordance with one or more aspects of the present disclosure. In some examples, wireless communications system 200 may implement or be implemented by one or more aspects of wireless communications system 100. For example, wireless communications system 200 may include a transmitter device 205 and a receiver device 210 which may be examples of an AP 105, an STA 115, or both as described with reference to FIG. 1. Additionally, the transmitter device 205 and the receiver device 210 may communicate within the coverage area 110-a, which may represent a BSA of the wireless communications system 200.

In some examples, transmitter device 205 may transmit data to the receiver device 210 in accordance with an MCS. An MCS may be associated with a type of modulation. For instance a given MCS may modulate a packet of data in accordance with the techniques of QAM, QPSK, BPSK, among other examples. Additionally, the given MCS may be associated with a code rate, which may correspond to a ratio between a quantity of information bits and a total number of bits (e.g., information bits plus redundancy bits) in a PSDU.

In some cases, it may be advantageous for the transmitter device 205 to transmit different portions of data using different spatial streams (e.g., connections made between the transmitter device 205 and the receiver device 210). For instance, the transmitter device 205 may transmit a first portion of a PSDU on a first spatial stream and transmit a second portion of the PSDU on a second spatial stream. In some cases, the transmitter device 205 may use multiple streams for communication in accordance with multi-input/multi-output (MIMO) communications with the receiver device 210. In some cases, however, MIMO channel measurements across multiple streams may experience large differences in channel quality across different eigen directions (e.g., differences in SNR across spatial streams). As such, the transmitter device 205 may determine respective MCSs per spatial stream to account for the difference in SNR among spatial streams. For instance, the first spatial steam may correspond to a first MCS and the second spatial steam may correspond to a second MCS. In some examples, multi-spatial stream transmissions may correspond to non-orthogonal frequency division multiple access (non-OFDMA) beamformed transmissions with or without channel puncture.

In some cases, it may be advantageous for the transmitter device 205 to transmit different portions of data using different RUs (e.g., bandwidth subcarrier frequencies used for both uplink and downlink communications for open loop (OL) OFDMA transmission). For instance, the transmitter device 205 may transmit a first portion of a PSDU on a first RU and transmit a second portion of the PSDU on a second RU. In some cases, however, channel measurements across multiple RUs or sub-bands may experience large differences in channel quality across different frequencies (e.g., differences in signal to interference and noise ratio (SINR) across RUs). As such, the transmitter device 205 may determine respective MCSs per RU to increase throughput from frequency selectivity. For instance, the first RU may correspond to a first MCS and the second RU may correspond to a second MCS. In some examples, each RU may have one or more respective spatial streams. In such examples, each spatial stream corresponding to a same RU may be associated with the same MCS.

In some examples, the transmitter device 205 and receiver device 210 may communicate using multiple RU (MRU) communications. As such, in both RU and MRU communications, the RUs may be split into RU components, where each RU component may correspond to a respective MCS and each respective MCS may be different for different RU components. In some examples, the transmitter device 205 may split communications across and up to four RU components. In some examples, the transmitter device 205 may split RUs into RU components without a loss of frequency tones (e.g., a 52-tone RU may split into two 26-tone RU components). In some examples, the transmitter device 205 may split RUs into RU components with some null tones that may not carrier data (e.g., a 106-tone RU may split into two 52-tone RU components with two null tones). In some examples, the transmitter device 205 may split MRUs into RU components (e.g., a 52+26-tone MRU may split into a 52-tone RU component and 26-tone RU component or split into three 26-tone RU components).

In accordance with multiple spatial streams and multiple RUs, the transmitter device 205 may support MAC layer and PHY layer processing to support unequal MCS across the spatial streams, or RUs, or both. The transmitter device 205 may use the MAC layer to generate one or more PSDUs for transmission to the receiver device 210. In accordance with MAC payload assignments for unequal MCS, the transmitter device 205 may prepare a single PSDU for transmission to the receiver device 210, or two or more PSDUs for transmission to the receiver device 210.

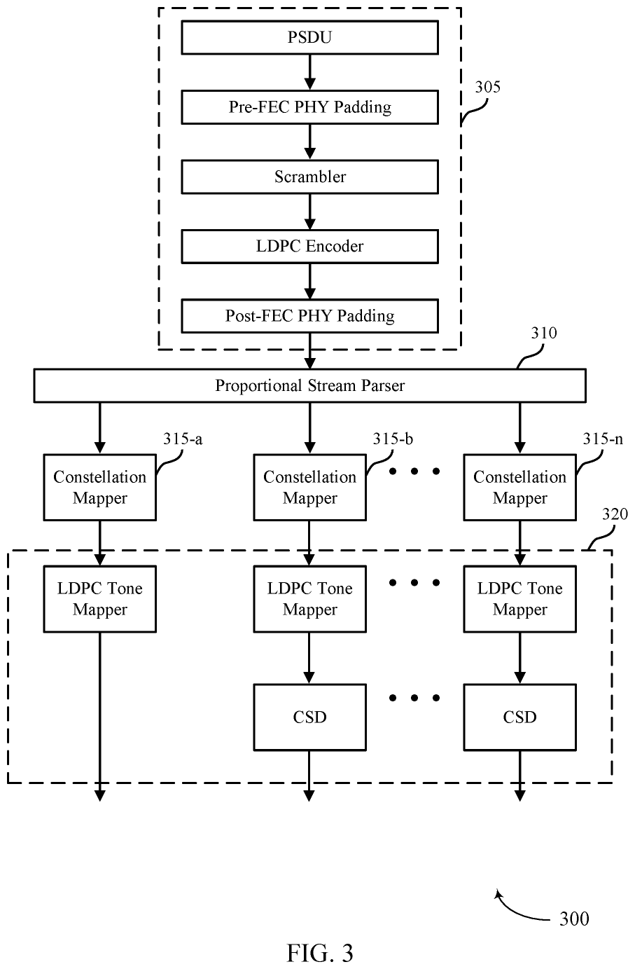

In the example of single PSDU transmissions, the transmitter device 205 may generate the PSDU in the MAC layer and encode the PSDU in the PHY layer (e.g., PSDU encoding and mapping procedure 220). In the PHY layer, the transmitter device 205 may split the bits of the PSDU across the different spatial streams or RUs in accordance with the different MCSs either before the encoding or after the encoding. In examples where each of the different MCSs have a same code rate, the transmitter device 205 may code information bits before splitting the coded bits into different spatial streams or RUs. In examples where each of the different MCSs have different code rates, the transmitter device 205 may split the information bits into different spatial streams or RUs before coding the information bits. Further discussion of encoding and mapping a single PSDU split across multiple spatial streams or RUs is described herein, including with reference to FIGS. 3 through 7.

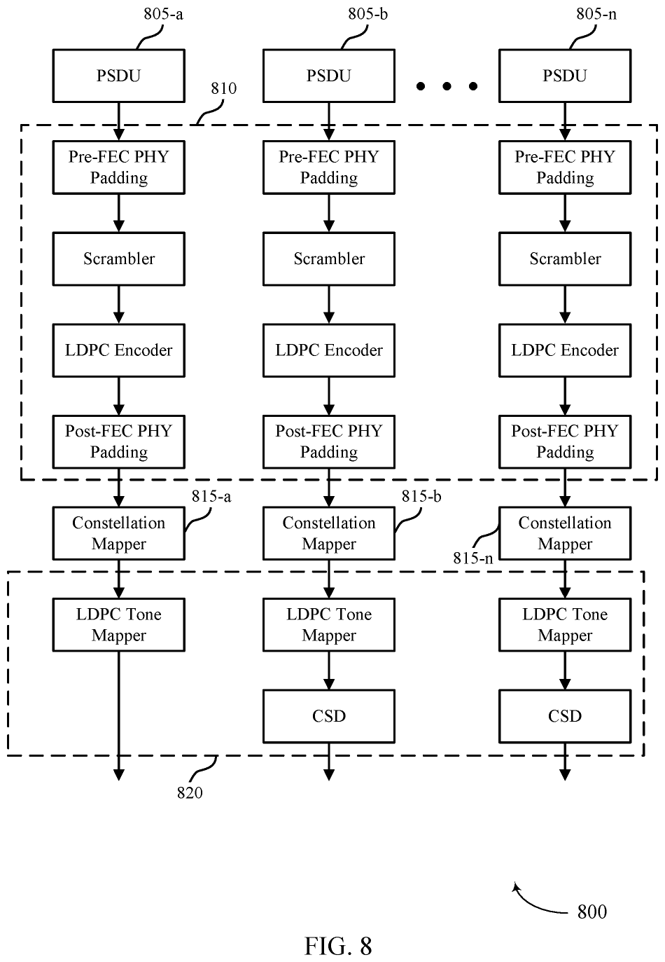

In the example of two or more PSDU transmissions, the transmitter device 205 may generate the multiple PSDUs in the MAC layer, where each of the multiple PSDUs corresponds to a different MCS. As such, in the MAC layer, the transmitter device 205 may prepare the multiple PSDUs such that different spatial streams or different RUs have roughly the same quantity of symbols for transmission (e.g., distribute the quantity of symbols across the spatial streams or RUs). In cases where a difference in the quantity of symbols between the multiple PSDUs is relatively large (e.g., the difference is above a threshold), the transmitter device 205 may use the MAC layer to include padding on PSDUs with a lower quantity of symbols to decrease the difference in symbol quantity between the PSDUs. In the PHY layer, the transmitter device 205 may perform separate encoding for each PSDU if the different corresponding MCSs have different coding rates (e.g., PSDU encoding and mapping procedure 220). In examples of different MCSs per spatial stream, the transmitter device 205 may function as an AP 105 to handle cases of multi-user MIMO (MU-MIMO). In examples of different MCSs per RU, the transmitter device 205 may function as an AP 105 to handle cases of multi-user OFDMA. In an example, a station (STA) may serve as an AP transmitting DL MU MIMO or may serve as an AP transmitting DL OFDMA in case of per RU MCS. On the receiver side, a STA may serve as AP receiving UL MU MIMO in case of per ss MCS or may serve as AP receiving UL OFDMA in case of per RU MCS. Further discussion of encoding and mapping a multiple PSDUs across multiple spatial streams or RUs are described herein, including with reference to FIGS. 8 through 10.

To support decoding of PSDUs at the receiver device 210 encoded using unequal MCSs across multiple spatial streams or RUs, the transmitter device 205 may transmit an MCS configuration message 215. For instance, the MCS configuration message 215 may be an example of a PHY preamble included in control signaling for PHY layer configuration. In some cases, the PHY preamble may include multiple signatures (SIGs), where the SIGs may be examples of user information fields (UIFs). For instance and in examples of ultra-high reliability (UHR), the PHY preamble may include a universal SIG (U-SIG), a UHR-SIG, an extremely high throughput (EHT) SIG (EHT-SIG), among other examples. As such, the fields of the MCS configuration message 215 may support indication of unequal MCS to the receiver device 210. In some examples, RU configuration may be carried in a common information field in the UHR-SIG, in a common information field in the EHT-SIG, or both. In some examples, a SIG field (e.g., an EHT-SIG field) may include a multiple parts. For example, the EHT-SIG may include a common field that may carry information for multiple users (e.g., information common across multiple receiver devices 210 communicating with the transmitter device 205). Additionally, the EHT-SIG may include a USF, that includes at least on UIF, where each UIF field in the USF includes information corresponding to a single user. For example, the USF may include a first UIF including information corresponding to a first receiver device 210 and a second UIF including information corresponding to a second receiver device 210.

In some examples, each MCS (e.g., for a spatial stream or an RU) in unequal MCSs may be treated as one user, such that each MCS has a respective UIF. As such, each of the UIFs corresponding to the MCSs associated with the receiver device 210 may share the same user ID. That is, each UIF intended for the receiver device 210 may include an indication corresponding to a user ID associated with the receiver device 210. In such examples, each UIF may include common information (e.g., coding information, beamforming information, etc.). In some cases, the common information may be redundant across the multiple UIFs. In examples of a single user transmission (e.g., a transmission from the transmitter device 205 to the receiver device 210), the transmitter device 205 may transmit the MCS configuration message 215 in accordance with a non-OFDMA multi-user transmission mode or an OFDMA transmission mode.

In some examples, indication of the multiple different MCSs per spatial stream or per RU may be included in one USF of the MCS configuration message 215. That is, the PHY preamble may include a USF that is associated with the receiver device 210, where the USF includes indication of each of the different MCSs that are associated with the spatial steams or RUs used at the receiver device 210 to receive the PSDUs.

In some cases, the transmitter device 205 may transmit the MCS configuration message 215 in accordance with a dynamic size hierarchical structure to save overhead and be backward compatible. For example, the hierarchical structure may include one or two bits to indicate if different MCSs are present across the spatial streams or RUs or if the different MCSs are the same across the spatial streams or RUs. For instance, the one to two bits may be an example of a UIF type field (e.g., included in the U-SIG or common field of the UHR-SIG). If the UIF type field indicates different MCSs across spatial streams or RUs, then each UIF corresponding to a respective MCS may be followed by an extension subfield indicating which spatial streams or RUs are associated with the respective MCS. In some other examples, the transmitter device 205 may transmit the MCS configuration message 215 in accordance with a fixed size structure. In such examples, the USF may include an indication of a respective MCS for each spatial stream or each RU (e.g., even in cases where multiple spatial streams or RUs share a same MCS).

In some cases, the transmitter device 205 may configure the quantity of bits included in each UIF. In some examples, each UIF in the SIG field may include four bits indicating the spatial stream and four bits for the MCS corresponding to the spatial steam. In some examples, the transmitter device 205 may configure a flexible bit quantity option that allows any combination of a quantity of streams and a quantity of MCSs (e.g., Nss×Nmcs) or any combination of a quantity of RUs and a quantity of MCSs (e.g., Nru×Nmcs).

In some cases, the transmitter device 205 may configure the quantity of bits in accordance with a compressed solution (e.g., limited set of MCS combinations allowed for a given spatial stream). In some examples, the transmitter device 205 may use a same or similar code rate and QAM for each MCS in a non-increasing order, where the step size between adjacent MCSs may be five to six dB. In some examples, the transmitter device 205 may order spatial streams according to a non-increasing order of the corresponding MCS coding rate. In such examples, the transmitter device 205 may reduce the quantity of bits by indicating differential MCS relative to the previous MCS in the field. In some examples, the transmitter device 205 may group the spatial streams into spatial stream subsets where each spatial stream subset corresponds to a different MCS. In such examples, the transmitter device 205 may signal the group size or quantity of groups to the receiver device 210. In such examples, the transmitter device 205 may configure two to four different subsets of spatial streams corresponding to two to four different MCSs.

In some examples, the UHR-SIG code block size may be increased relative to the EHT-SIG code block size to satisfy the increase in bits included in each UIF. The EHT-SIG code block structure may use one code block to encode the common field and the first UIF or two UIFs. In some examples, the transmitter device 205 may determine for the EHT-SIG code block size to be below a bit threshold (e.g., below, or equal to 64 bits including a four-bit cyclic redundancy check (CRC) and six-bit tail). As such, if the increase quantity of bits per UIF is large (e.g., greater than five bits), the transmitter device 205 may encode the respective fields of UHR-SIG different than the EHT-SIG. For instance, the transmitter device 205 may encode the common field and the first UIF separately (e.g., use one code block for the common field and one code block for the first UIF). Additionally or alternatively, the transmitter device 205 may encode the fields of the UHR-SIG using a fixed code block size (e.g., 64 bits including a four-bit CRC and a six-bit tail), for the entire common field and UIF field stream encoding.

In examples of single user transmissions, the transmitter device 205 may increase the size of each UIF included in the U-SIG. In examples of EHT, the signaling of the single user transmission may be based on the length of the EHT-SIG. Due to increase size per UIF in a single user transmission, the number of UHR-SIG symbols may increase, and the combination of the quantity of UHR-SIG and UHR-SIG MCS may increase to indicate a single user transmission. Additionally or alternatively, the transmitter device 205 may include one bit or one distinct state in a PHY layer protocol data unit (PPDU) and compression mode in the U-SIG to signal the single user transmission.

As such, the transmitter device 205 may perform the PSDU encoding and mapping procedure 220 in accordance with the MCS spatial stream or RU configuration indicated in the MCS configuration message 215. As such, the transmitter device may proceed to transmit the one or more PSDUs prepared (e.g., using the PSDU encoding and mapping procedure 220) in a PSDU transmission 225. The receiver device 210 may receive the PSDU transmission 225 and decode the one or more PSDUs using the MCS information provided in the MCS configuration message 215.

FIG. 3 shows an example of a single PSDU encoding procedure 300 that supports signaling for multiple coding schemes to a single user device in accordance with one or more aspects of the present disclosure. In some examples, single PSDU encoding procedure 300 may implement or be implemented by one or more aspects of wireless communications system 100 and 200. For example, single PSDU encoding procedure 300 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the PHY layer. In some cases, the encoding process illustrated in single PSDU encoding procedure 300 may correspond to a case of same code rates and different modulations across respective MCSs associated with respective spatial streams. The transmitter device 205 may apply the single PSDU encoding procedure 300 for per stream MCS for full bandwidth beamformed transmission.

Based on the respective MCSs having the same code rate, the transmitter device 205 may encode the bits of the single PSDU first and split the coded bits of the single PSDU into different spatial streams. In some examples, the transmitter device 205 may encode the bits in accordance with encoding procedure 305. For example, the transmitter device 205 may perform a pre-forward error correction (FEC) PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain). Based on performing the scrambling, the transmitter device 205 may perform encoding on the PSDU. While FIG. 3 illustrates the use of low-density parity check (LDPC) encoding, it is understood that the techniques of FIG. 3 may use other forms of encoding such as binary convolutional code (BCC), among other examples. Based on performing the encoding, the transmitter device 205 may perform post-FEC PHY padding (e.g., padding the single PSDU with additional bits such that the quantity of bits of the single PSDU satisfies a post-FEC bit threshold). As described with reference to FIG. 3, the transmitter device 205 may encode the bits of the single PSDU prior to splitting the bits across a set of spatial streams, based on the different MCSs corresponding to the respective spatial streams having a same code rate.

Based on performing the encoding procedure 305, the transmitter device 205 may split the encoded bits of the single PSDU into subsets of bits using the proportional stream parser 310. For example, the proportional stream parser 310 may parse the coded bits into respective subsets of bits corresponding to respective spatial streams. In some cases, the quantity of bits in a given subset of bits may be proportional to the modulation size of the MCS corresponding to the spatial stream the given subset of bits is assigned to.

As illustrated in FIG. 3, each spatial stream may be associated with a respective constellation mapper 315 (e.g., constellation mapper 315-a, 315-b, and 315-n). Each constellation mapper 315 may map the subset of bits parsed to the associated spatial stream into a respective constellation size associated with the corresponding MCS. As such, each constellation mapper 315 may be based on the type of modulation for the corresponding MCS (e.g., QAM, QPSK, BPSK, among other examples). While FIG. 3 illustrates three constellation mappers 315 corresponding to three spatial streams, it is understood that the transmitter device 205 may use the PHY layer to parse the bits of the single PSDU to any quantity of spatial streams associated with any quantity of MCSs.

Based on mapping the bits using the respective constellation mappers 315, the transmitter device 205 may perform PSDU finalization procedure 320. For example, the transmitter device 205 may perform tone mapping using a respective tone mapper associated with each spatial stream. In some examples, the transmitter device 205 may use a given tone mapper to permute the stream of constellation points to obtain the corresponding spatial stream. While FIG. 3 illustrates the use LDPC tone mappers, it is understood that the techniques of FIG. 3 may use other forms of interleaving such as BCC interleaving, among other examples. Based on performing tone mapping, the transmitter device 205 may apply a respective cyclic shift diversity (CSD) to one or more of the spatial streams. A CSD may be used to apply a cyclic delay to each of the spatial streams to increase the channel frequency diversity and reduce correlation between the transmission on each spatial steam.

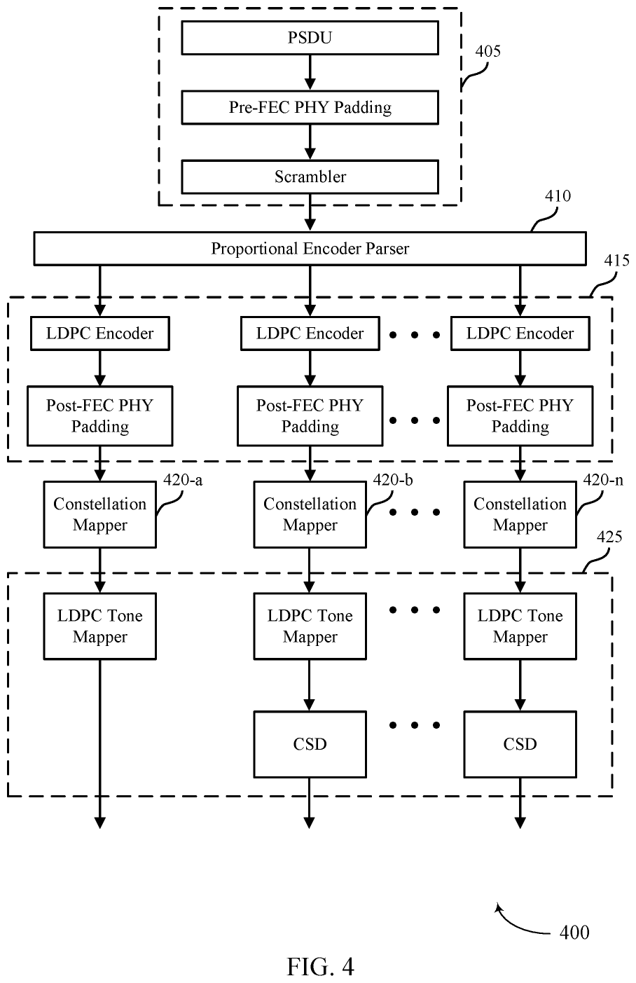

FIG. 4 shows an example of a single PSDU encoding procedure 400 that supports signaling for multiple coding schemes to a single user device in accordance with one or more aspects of the present disclosure. In some examples, single PSDU encoding procedure 400 may implement or be implemented by one or more aspects of wireless communications system 100 and 200. For example, single PSDU encoding procedure 400 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the PHY layer. In some cases, the encoding process illustrated in single PSDU encoding procedure 400 may correspond to a case where respective MCSs correspond to different spatial streams, such that each of the respective MCSs has a different code rate. The transmitter device 205 may apply the single PSDU encoding procedure 400 for per stream MCS for full bandwidth beamformed transmission.

In some examples, the transmitter device 205 may perform an initial PSDU preparation procedure 405 using the PHY layer. For example, the transmitter device 205 may perform pre-FEC PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain).

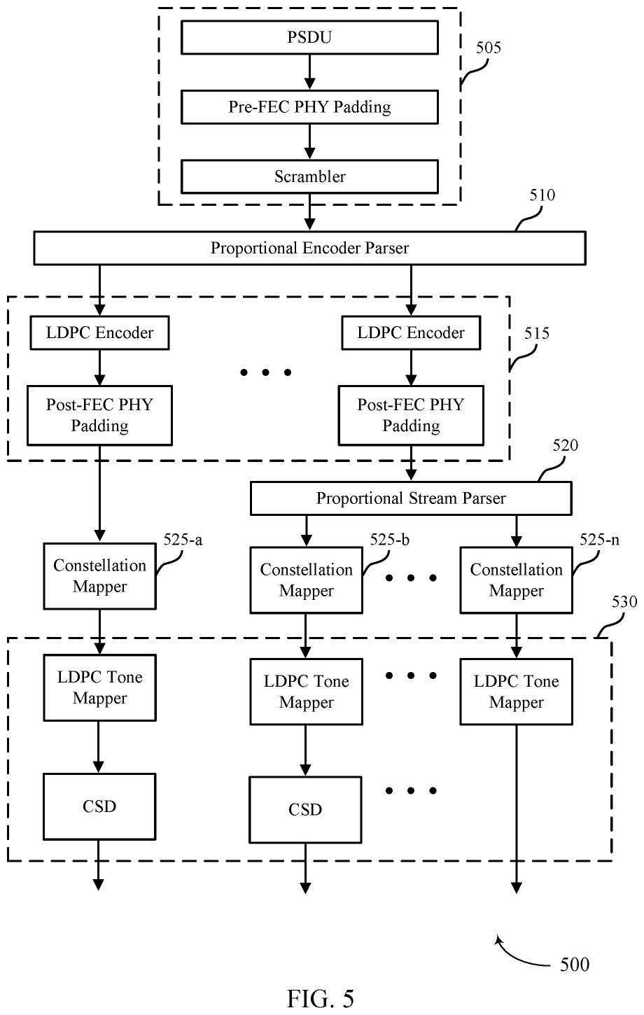

Based on the respective MCSs having different code rates, the transmitter device 205 may separate encoding for the different code rates of the respective MCSs. For instance, the transmitter device 205 may use a proportional encoder parser 410 to parse the bits of the single PSDU into respective subsets of bits corresponding to the respective spatial streams. In some examples, the proportional encoder parser 410 may determine the quantity of bits for a given subset of bits based on the coding rate and modulation size of the MCS corresponding to the spatial stream the given subset of bits is assigned to. While FIG. 4 illustrates three spatial streams, it is understood that the transmitter device 205 may use the PHY layer to parse the bits of the single PSDU into any quantity of spatial streams associated with any quantity of MCSs. In some cases, the quantity of encoders may be dependent on the quantity of MCSs or different code rates in the assigned MCSs. Additionally, FIG. 4 illustrates the case where the quantity of encoders, spatial streams, and MCSs are equal, and thus a stream parser may not be needed. Discussion of a case where the quantity of encoders is less than the quantity of spatial streams is described herein, with reference to FIG. 5.

Based on parsing the single PSDU into respective subsets of bits, the transmitter device 205 may encode the respective subsets of bits in accordance with the encoding procedure 415. For example, each respective subset of bits may be encoded using a respective encoder associated with the MCS for the corresponding spatial steam. While FIG. 4 illustrates the use of LDPC encoding, it is understood that the techniques of FIG. 4 may use other forms of encoding such as BCC, among other examples. Based on performing the respective encoding for each subset of bits, the transmitter device 205 may perform post-FEC PHY padding (e.g., padding the respective subsets of bits with additional bits such that the quantity of bits for each of the respective subset of bits satisfies a post-FEC bit threshold).

As illustrated in FIG. 4, each spatial stream may be associated with a respective constellation mapper 420 (e.g., constellation mapper 420-a, 420-b, and 420-n). Each constellation mapper 420 may map the subset of bits parsed to the associated spatial stream into a respective constellation size associated with the corresponding MCS. As such, each constellation mapper 420 may be based on the type of modulation for the corresponding MCS (e.g., QAM, QPSK, BPSK, among other examples).

Based on mapping the bits using the respective constellation mappers 420, the transmitter device 205 may perform a PSDU finalization procedure 425. For example, the transmitter device 205 may perform tone mapping using a respective tone mapper associated with each spatial stream. In some examples, the transmitter device 205 may use a given tone mapper to permute the stream of constellation points to obtain the corresponding spatial stream. While FIG. 4 illustrates the use LDPC tone mappers, it is understood that the techniques of FIG. 4 may use other forms of interleaving such as BCC interleavers, among other examples. Based on performing tone mapping, the transmitter device 205 may apply a respective CSD to one or more of the spatial streams. A CSD may be used to apply a cyclic delay to each of the spatial streams to increase the channel frequency diversity and reduce correlation between the transmission on each spatial steam.

FIG. 5 shows an example of a single PSDU encoding procedure 500 that supports signaling for multiple coding schemes to a single user device in accordance with one or more aspects of the present disclosure. In some examples, single PSDU encoding procedure 500 may implement or be implemented by one or more aspects of wireless communications system 100 and 200. For example, single PSDU encoding procedure 500 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the PHY layer. In some cases, the encoding process illustrated in single PSDU encoding procedure 500 may correspond to a case where respective MCSs correspond to different spatial streams, such that at least one of the respective MCSs has a different code rate. That is, one or more MCSs may share a same code rate and at least one other MCS has a different code rate. The transmitter device 205 may apply the single PSDU encoding procedure 500 for per stream MCS for full bandwidth beamformed transmission.

In some examples, the transmitter device 205 may perform an initial PSDU preparation procedure 505 using the PHY layer. For example, the transmitter device 205 may perform pre-FEC PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain). In some examples, when the quantity of encoders is less than the quantity of spatial streams (e.g., Nencoder<Nss), a stream parser may be used to separate the coded bits to different streams. In some examples, some of the streams may have a same code rate and are jointly encoded together.

Based on one or more of the respective MCSs having different code rates, the transmitter device 205 may separate encoding for the different code rates of the respective MCSs. For instance, the transmitter device 205 may use a proportional encoder parser 510 to parse the bits of the single PSDU into respective subsets of bits corresponding to the respective code rates. That is, a first encoder may correspond to one or more MCSs sharing a first code rate a second encoder may correspond to one or more MCSs sharing a second code rate.

In some examples, the proportional encoder parser 510 may determine the quantity of bits for a given subset of bits based on the shared code rate and one or more modulation sizes of the one or more MCSs corresponding to a given encoder.

Based on parsing the single PSDU into respective subsets of bits, the transmitter device 205 may encode the respective subsets of bits in accordance with the encoding procedure 515. For example, each respective subset of bits may be encoded using a respective encoder. As such, each encoder may be based on the shared coding rate corresponding to the one or more MCSs associated with the encoder. While FIG. 5 illustrates the use of LDPC encoding, it is understood that the techniques of FIG. 5 may use other forms of encoding such as BCC, among other examples. Based on performing the respective encoding for each subset of bits, the transmitter device 205 may perform post-FEC PHY padding (e.g., padding the respective subsets of bits with additional bits such that the quantity of bits for each of the respective subset of bits satisfies a post-FEC bit threshold).

For encoders associated with multiple MCSs sharing a same coding rate, the transmitter device 205 may use a proportional stream parser 520 to further parse the respective subset of bits into respective sub-subsets of bits corresponding to respective MCSs of the multiple MCSs. For instance, as illustrated in FIG. 5, an encoder may be associated with two MCSs sharing a same code rate. As such, the subset of bits encoded using the encoder may be split (e.g., via the proportional stream parser 520) into a first sub-subset of bits corresponding to the a first MCS of the two MCSs and into a second sub-subset of bits corresponding to a second MCS of the two MCSs. In such an example, the quantity of bits in each sub-subset may be based on the modulation size of the corresponding MCS. As illustrated in FIG. 5, for encoders associated with a single encoder, the transmitter device 205 may refrain from using a proportional stream parser 520.

As illustrated in FIG. 5, each spatial stream may be associated with a respective constellation mapper 525 (e.g., constellation mapper 525-a, 525-b, and 525-n). Each constellation mapper 525 may map the subset of bits parsed to the associated spatial stream into a respective constellation size associated with the corresponding MCS. As such, each constellation mapper 525 may be based on the type of modulation for the corresponding MCS (e.g., QAM, QPSK, BPSK, among other examples).

Based on mapping the bits using the respective constellation mappers 525, the transmitter device 205 may perform a PSDU finalization procedure 530. For example, the transmitter device 205 may perform tone mapping using a respective tone mapper associated with each spatial stream. In some examples, the transmitter device 205 may use a given tone mapper to permute the stream of constellation points to obtain the corresponding spatial stream. While FIG. 5 illustrates the use LDPC tone mappers, it is understood that the techniques of FIG. 5 may use other forms of interleaving such as BCC interleavers, among other examples. Based on performing tone mapping, the transmitter device 205 may apply a respective CSD to one or more of the spatial streams. A CSD may be used to apply a cyclic delay to each of the spatial streams to increase the channel frequency diversity and reduce correlation between the transmission on each spatial steam.

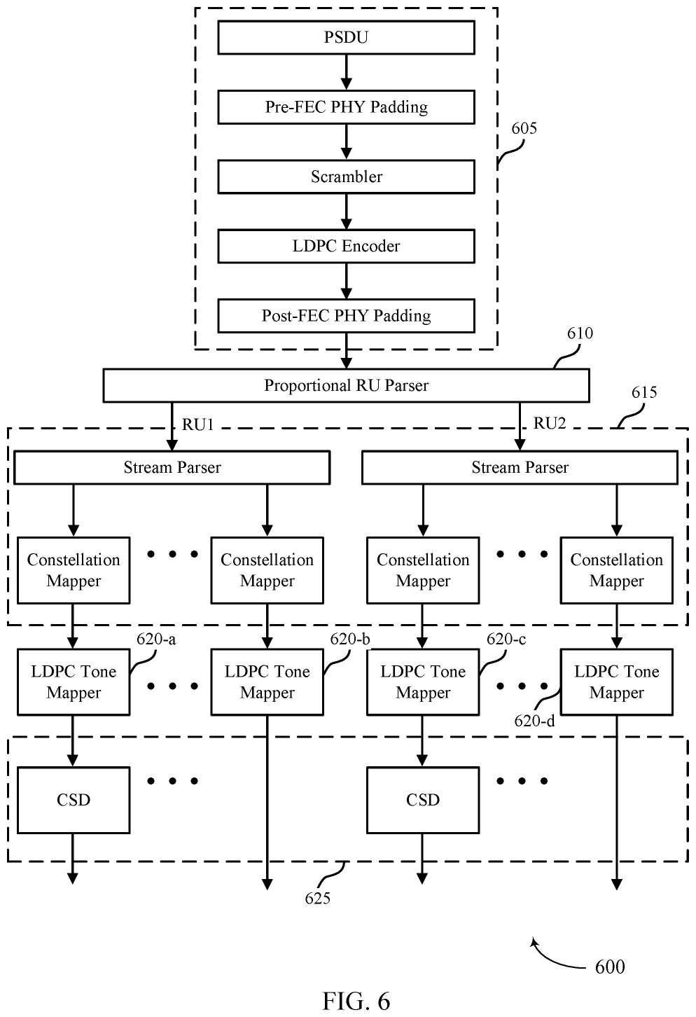

FIG. 6 shows an example of single PSDU encoding procedure 600 that supports signaling for multiple coding schemes to a single user device in accordance with one or more aspects of the present disclosure. In some examples, single PSDU encoding procedure 600 may implement or be implemented by one or more aspects of wireless communications system 100 and 200. For example, single PSDU encoding procedure 600 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the in the PHY layer. In some cases, the encoding process illustrated in single PSDU encoding procedure 600 may correspond to a case of same code rates and different modulations across respective MCSs associated with respective RUs. For instance, the process of FIG. 6 may illustrate two RUs, where RU1 is associated to a first MCS and RU2 is associated with a second MCS. As such, the first MCS and second MCS may share a same coding rate and have different modulations. In some examples, RU1 and RU2 may be part of an MRU. For example, the process of FIG. 6 may provide for per RU MCS for OL OFDMA transmission with MRU assignments, where joint encoding for a same code rate but with different modulation, a proportional RU parser may be used to parse coded bits to each RU in MRU proportionally to products of RU size and modulation size.

Based on the respective MCSs having the same code rate, the transmitter device 205 may encode the bits of the single PSDU first and split the coded bits of the single PSDU into different RUs. In some examples, the transmitter device 205 may encode the bits in accordance with encoding procedure 605. For example, the transmitter device 205 may perform a pre-FEC PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain). Based on performing the scrambling, the transmitter device 205 may perform encoding on the PSDU. While FIG. 6 illustrates the use of LDPC encoding, it is understood that the techniques of FIG. 6 may use other forms of encoding such as BCC, among other examples. Based on performing the encoding, the transmitter device 205 may perform post-FEC PHY padding (e.g., padding the single PSDU with additional bits such that the quantity of bits of the single PSDU satisfies a post-FEC bit threshold). As described with reference to FIG. 6, the transmitter device 205 may encode the bits of the single PSDU prior to splitting the bits across RU1 and RU2.

Based on performing the encoding procedure 605, the transmitter device 205 may split the encoded bits of the single PSDU into subsets of bits using a proportional RU parser 610. For example, the proportional RU parser 610 may parse the coded bits into respective subsets of bits corresponding to respective RUs. In some cases, the quantity of bits in a given subset of bits may be proportional to a product of the modulation size of the corresponding MCS and the size of the RU the given subset of bits is assigned to. While FIG. 6 illustrates parsing the coded bits of the single PSDU to two RUs, it is understood that the coded bits may be parsed into any quantity of subset of bits corresponding to any quantity of RUs.

As such, the transmitter device 205 may perform a stream mapping procedure 615 for each of the subset of bits corresponding to the respective RUs. For instance, a respective stream parser may parse a subset of bits into sub-subsets of bits corresponding to the spatial streams associated with the corresponding RU. As described with reference to FIG. 2, each of the spatial streams associated with a given RU may have a same MCS. Additionally, the quantity of bits in a given sub-subset of bits may be proportional to the modulation size of the MCS corresponding to the RU and the encoded bits may be parsed to each spatial stream via a round robin procedure. Additionally, each spatial stream may be associated with a respective constellation mapper. For instance, each constellation mapper may map the sub-subset of bits parsed to the associated spatial stream into a respective constellation size associated with the corresponding MCS for the associated RU. As such, each constellation mapper may be based on the type of modulation for the corresponding MCS (e.g., QAM, QPSK, BPSK, among other examples) of the RU. It is understood that each RU may be associated with any quantity of special streams corresponding to any quantity of constellation mappers.

Based on mapping the bits using the respective constellation mappers 620, the transmitter device 205 may perform tone mapping using respective tone mappers 620 (tone mapper 620-a, 620-b, 620-c, and 620-d) associated with RU size. In some examples, the transmitter device 205 may use a given tone mapper 620 to permute the stream of constellation points to obtain the corresponding spatial stream. While FIG. 6 illustrates the use LDPC tone mappers, it is understood that the techniques of FIG. 6 may use other forms of interleaving such as BCC interleavers, among other examples. Additionally, the tone mappers 620 may operate within each RU rather than within the MRU to separate given modulation schemes assigned to each RU of the MRU.

Based on performing tone mapping, the transmitter device 205 may perform a PSDU finalization procedure 625. For example, the transmitter device 205 may apply a respective CSD to one or more of the spatial streams. A CSD may be used to apply a cyclic delay to each of the spatial streams to increase the channel frequency diversity and reduce correlation between the transmission on each spatial steam.

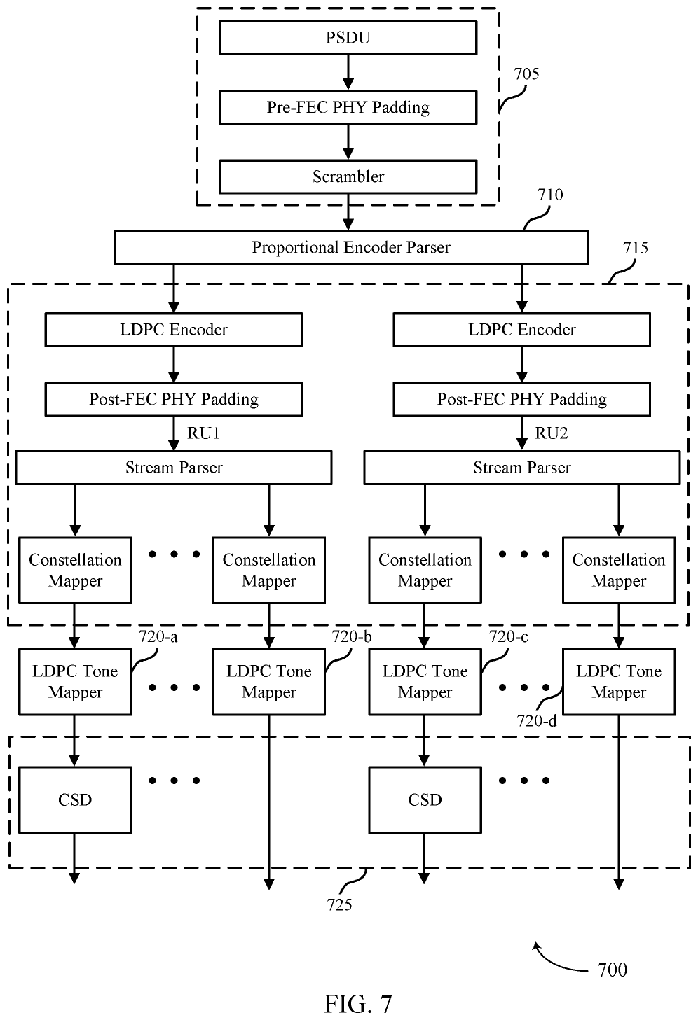

FIG. 7 shows an example of a single PSDU encoding procedure 700 that supports signaling for multiple coding schemes to a single user device in accordance with one or more aspects of the present disclosure. In some examples, single PSDU encoding procedure 700 may implement or be implemented by one or more aspects of wireless communications system 100 and 200. For example, single PSDU encoding procedure 700 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the PHY layer. In some cases, the encoding process illustrated in single PSDU encoding procedure 700 may correspond to a case where respective RUs of an MRU are associated with respective MCSs that have different code rates. For instance, the process of FIG. 7 may illustrate two RUs, where RU1 is associated to a first MCS and RU2 is associated with a second MCS. As such, the first MCS and second MCS may have different code rates. In some examples, RU1 and RU2 may be part of an MRU. For example, the process of FIG. 7 may provide for per RU MCS for OL OFDMA transmission with MRU assignments, where separate encoding for different code rates in assigned MCSs uses a proportional encoder parser for parsing information bits for each RU proportionally to products of MCS and RU size.

In some examples, the transmitter device 205 may perform an initial PSDU preparation procedure 705 using the PHY layer. For example, the transmitter device 205 may perform pre-FEC PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain).

Based on the respective MCSs for each RU having different code rates, the transmitter device 205 may separate encoding for each of the RUs. For instance, the transmitter device 205 may use a proportional encoder parser 710 to parse the bits of the single PSDU into respective subsets of bits corresponding to the respective RUs. In some examples, the proportional encoder parser 710 may determine the quantity of bits as a product of the modulation size of the corresponding MCS and the size of the RU the given subset of bits is assigned to.

Based on parsing the single PSDU into respective subsets of bits, the transmitter device 205 may encode the respective subsets of bits in accordance with the encoding procedure 715. For example, each respective subset of bits may be encoded using a respective encoder associated with the MCS for the corresponding RU. While FIG. 7 illustrates the use of LDPC encoding, it is understood that the techniques of FIG. 7 may use other forms of encoding such as BCC, among other examples. Based on performing the respective encoding for each subset of bits, the transmitter device 205 may perform post-FEC PHY padding (e.g., padding the respective subsets of bits with additional bits such that the quantity of bits for each of the respective subset of bits satisfies a post-FEC bit threshold).

As such, the transmitter device 205 may perform stream mapping for each of the subset of bits corresponding to the respective RUs. For instance, each RU may be associated with a respective stream parser that may parse a subset of bits into sub-subsets of bits corresponding to the spatial streams associated with the corresponding RU. As described with reference to FIG. 2, each of the spatial streams associated with a given RU may have a same MCS. Additionally, the quantity of bits in a given sub-subset of bits may be proportional to the modulation size of the MCS corresponding to the RU and the encoded bits are parsed to each spatial stream in a round robin way. Additionally, each spatial stream may be associated with a respective constellation mapper. For instance, each constellation mapper may map the sub-subset of bits parsed to the associated spatial stream into a respective constellation size associated with the corresponding MCS for the associated RU. As such, each constellation mapper may be based on the type of modulation for the corresponding MCS (e.g., QAM, QPSK, BPSK, among other examples). It is understood that each RU may be associated with any quantity of spatial streams corresponding to any quantity of constellation mappers.

Based on mapping the bits using the respective constellation mappers, the transmitter device 205 may perform tone mapping using respective tone mappers 720 (tone mapper 720-a, 720-b, 720-c, and 720-d) associated with each spatial stream. In some examples, the transmitter device 205 may use a given tone mapper 720 to permute the stream of constellation points to obtain the corresponding spatial stream. While FIG. 7 illustrates the use LDPC tone mappers, it is understood that the techniques of FIG. 7 may use other forms of interleavers such as BCC interleavers, among other examples. Additionally, the tone mappers 720 may operate within each RU rather than within the MRU to separate given modulation schemes assigned to each RU of the MRU (e.g., to keep each QAM within its assigned RU).

Based on performing tone mapping, the transmitter device 205 may perform a PSDU finalization procedure 725. For example, the transmitter device 205 may apply a respective CSD to one or more of the spatial streams. A CSD may be used to apply a cyclic delay to each of the spatial streams to increase the frequency diversity and reduce correlation between the transmission on each spatial steam.

FIG. 8 shows an example of a multi-PSDU encoding procedure 800 that supports signaling for multiple coding schemes to a single user device in accordance with one or more aspects of the present disclosure. In some examples, multi-PSDU encoding procedure 800 may implement or be implemented by one or more aspects of wireless communications system 100 and 200. For example, multi-PSDU encoding procedure 800 may be an example of the PSDU encoding and mapping procedure 220 performed by the transmitter device 205, as described with reference to FIG. 2.

As discussed with reference to FIG. 2, the transmitter device 205 may generate two or more PSDUs 805 in the MAC layer. As illustrated in FIG. 8, the transmitter device 205 may generate PSDU 805-a, 805-b, and 805-n. As such, the generated PSDUs 805 may be encoded in the in the PHY layer. The process of FIG. 8 may be used for per stream MCS for full bandwidth beamformed transmission. In some cases, the encoding process illustrated in multi-PSDU encoding procedure 800 may be a case where each PSDU 805 corresponds to a respective spatial stream and a respective MCS, where the transmitter device 205 may process each stream separately. While FIG. 8 illustrates three PSDUs 805, it is understood that the transmitter device 205 may concurrently generate any quantity of PSDUs 805 in the MAC layer. In some examples, each PSDU corresponds to a single stream and a single MCS, where the quantity of PSDUs, streams, and encoders are equal, and thus each stream is processed separately and a stream parser may be omitted.

Based on each PSDU 805 corresponding to a respective spatial stream, the transmitter device 205 may refrain from parsing the bits of a given PSDU 805 into multiple subset of bits. As such, the transmitter device 205 may encode the bits of each PSDU 805 in accordance with encoding procedure 810. For example, the transmitter device 205 may perform a pre-FEC PHY padding (e.g., padding each PSDU 805 with additional respective bits such that the quantity of bits for each PSDU 805 satisfies a pre-FEC bit threshold). Based on performing the pre-FEC PHY padding, the transmitter device 205 may use a scramble for each PSDU 805 (e.g., a device that transposes or inverts signals in the analog domain). Based on performing the scrambling, the transmitter device 205 may perform respective encoding on each PSDU 805. For instance the respective encoding may correspond to the MCS associated with a given spatial stream. While FIG. 8 illustrates the use of LDPC encoding, it is understood that the techniques of FIG. 8 may use other forms of encoding such as BCC, among other examples. Based on performing the encoding, the transmitter device 205 may perform post-FEC PHY padding for each PSDU 805 (e.g., padding each PSDU 805 with additional respective bits such that the quantity of bits for each PSDU 805 satisfies a post-FEC bit threshold). In some examples the transmitter device 205 may encode the bits of each PSDU 805 concurrently.

As illustrated in FIG. 8, each spatial stream may be associated with a respective constellation mapper 815 (e.g., constellation mapper 815-a, 815-b, and 815-n). Each constellation mapper 815 may map the bits of the PSDU 805 for a given spatial stream into a respective constellation size associated with the corresponding MCS. As such, each constellation mapper 815 may be based on the type of modulation for the corresponding MCS (e.g., QAM, QPSK, BPSK, among other examples).

Based on mapping the bits of each PSDU 805 using the respective constellation mappers 815, the transmitter device 205 may perform PSDU finalization procedure 820. For example, the transmitter device 205 may perform tone mapping using a respective tone mapper associated with each spatial stream. In some examples, the transmitter device 205 may use a given tone mapper to permute the stream of constellation points to obtain the corresponding spatial stream. While FIG. 8 illustrates the use LDPC tone mappers, it is understood that the techniques of FIG. 8 may use other forms of interleaving such as BCC interleavers, among other examples. Based on performing tone mapping, the transmitter device 205 may apply a CSD to one or more of the spatial streams. A CSD may be used to apply a cyclic delay to each of the spatial streams to increase the frequency diversity and reduce correlation between the transmission of the PSDUs 805 on each spatial steam.

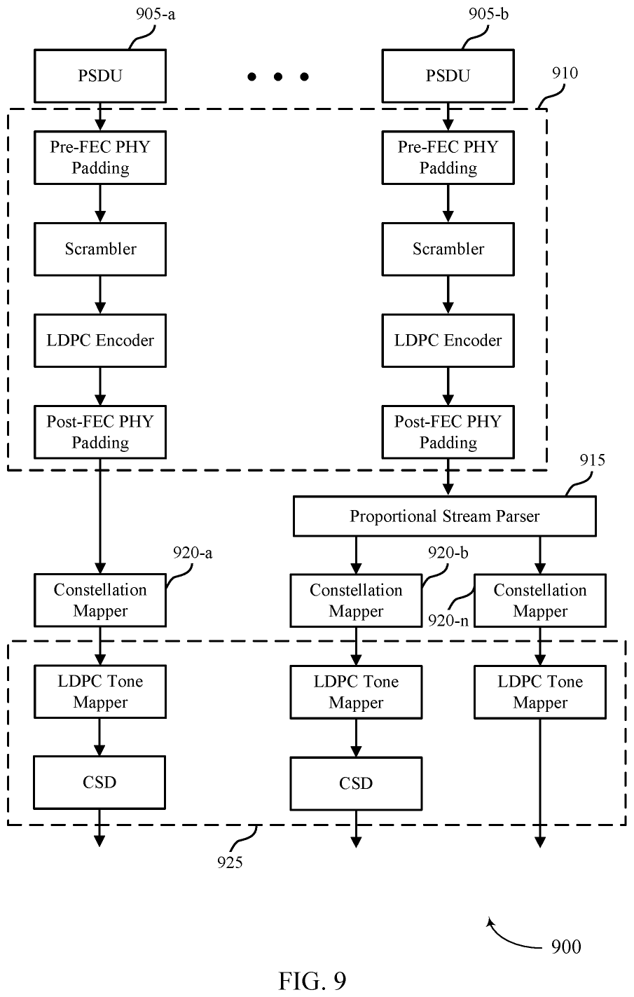

FIG. 9 shows an example of a multi-PSDU encoding procedure 900 that supports signaling for multiple coding schemes to a single user device in accordance with one or more aspects of the present disclosure. In some examples, multi-PSDU encoding procedure 900 may implement or be implemented by one or more aspects of wireless communications system 100 and 200. For example, multi-PSDU encoding procedure 900 may be an example of the PSDU encoding and mapping procedure 220 performed by the transmitter device 205, as described with reference to FIG. 2.

As discussed with reference to FIG. 2, the transmitter device 205 may generate two or more PSDUs 905 in the MAC layer. As illustrated in FIG. 9, the transmitter device 205 may generate PSDU 905-a and 905-b. As such, the generated PSDUs 905 may be encoded in the PHY layer. In some cases, the encoding process illustrated in multi-PSDU encoding procedure 900 may be a case where MCSs with a same code rate may share a same PSDU 905. For instance, as illustrated in FIG. 9, PSDU 905-b may be associate with two or more MCSs that may share the same code rate but different modulations. Based on the two or more MCSs sharing the same code rate, the bits of the PSDU 905-b may be encoded using one encoder, which may reduce the quantity of encoders used. While FIG. 9 illustrates two PSDUs 905, it is understood that the transmitter device 205 may concurrently generate any quantity of PSDUs 905 in the MAC layer. In some examples, the process of FIG. 9 may be used for per stream MCS for full bandwidth beamformed transmission.

Based on each PSDU 905 corresponding to one or more MCSs of a same code rate, the transmitter device 205 may encode the bits of each PSDU 905 in accordance with encoding procedure 910. For example, the transmitter device 205 may perform a pre-FEC PHY padding (e.g., padding each PSDU 905 with additional respective bits such that the quantity of bits for each PSDU 905 satisfies a pre-FEC bit threshold). Based on performing the pre-FEC PHY padding, the transmitter device 205 may use a scramble for each PSDU 905 (e.g., a device that transposes or inverts signals in the analog domain). Based on performing the scrambling, the transmitter device 205 may perform respective encoding on each PSDU 905. For instance the respective encoding may correspond to the MCS associated with a given spatial stream. While FIG. 9 illustrates the use of LDPC encoding, it is understood that the techniques of FIG. 9 may use other forms of encoding such as BCC, among other examples. Based on performing the encoding, the transmitter device 205 may perform post-FEC PHY padding for each PSDU 905 (e.g., padding each PSDU 905 with additional respective bits such that the quantity of bits for each PSDU 905 satisfies a post-FEC bit threshold). In some examples the transmitter device 205 may encode the bits of each PSDU 905 concurrently.

Based on PSDU 905-b being associated with multiple MCSs, the transmitter device 205 may separate the bits of PSDU 905-b into subsets of bits. For example, the proportional stream parser 915 may parse the bits of the PSDU 905-a into respective subsets of bits corresponding to respective MCSs of the multiple MCSs associated with PSDU 905-b. In such examples, the quantity of bits in each subset of bits may be based on the modulation size of the corresponding MCS. As such, the bits of PSDU 905-b may be split into respective subsets of bits corresponding to respective spatial streams. While FIG. 9 illustrates the PSDU 905-b being split into two subsets of bits, it is understood that the proportional stream parser may split a given PSDU 905 into any quantity of subsets of bits corresponding to any quantity of spatial streams. In some examples, to reduce the quantity of encoders (N_encoder), one or more MCSs with a same code rate may share one PSDU and one encoder, where the stream parser 915 is used to split the bits between multiple constellation mappers.

As illustrated in FIG. 9, each spatial stream may be associated with a respective constellation mapper 920 (e.g., constellation mapper 920-a, 920-b, and 920-n). Each constellation mapper 920 may map the bits of the PSDU 905 for a given spatial stream into a respective constellation size associated with the corresponding MCS. As such, each constellation mapper 920 may be based on the type of modulation for the corresponding MCS (e.g., QAM, QPSK, BPSK, among other examples).

Based on mapping the bits of each PSDU 905 using the respective constellation mappers 920, the transmitter device 205 may perform PSDU finalization procedure 925. For example, the transmitter device 205 may perform tone mapping using a respective tone mapper associated with each spatial stream. In some examples, the transmitter device 205 may use a given tone mapper to permute the stream of constellation points to obtain the corresponding spatial stream. While FIG. 9 illustrates the use LDPC tone mappers, it is understood that the techniques of FIG. 9 may use other forms of interleaving such as BCC interleavers, among other examples. Based on performing tone mapping, the transmitter device 205 may apply a CSD to one or more of the spatial streams. A CSD may be used to apply a cyclic delay to each of the spatial streams to increase the frequency diversity and reduce correlation between the transmission on each spatial steam.

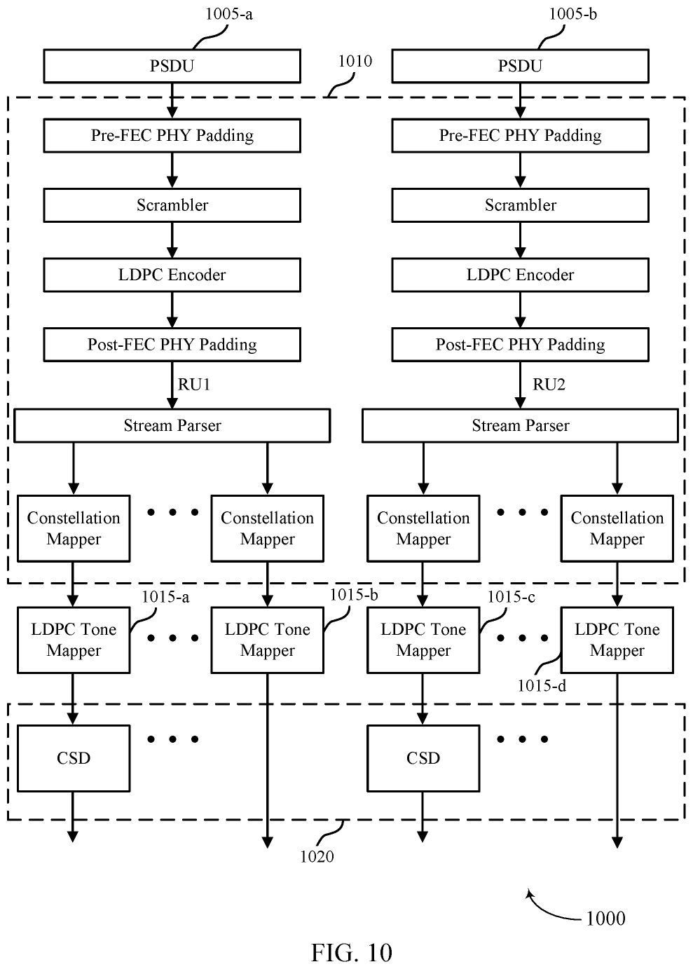

FIG. 10 shows an example of a multi-PSDU encoding procedure 1000 that supports signaling for multiple coding schemes to a single user device in accordance with one or more aspects of the present disclosure. In some examples, multi-PSDU encoding procedure 1000 may implement or be implemented by one or more aspects of wireless communications system 100 and 200. For example, multi-PSDU encoding procedure 1000 may be an example of the PSDU encoding and mapping procedure 220 performed by the transmitter device 205, as described with reference to FIG. 2.

As discussed with reference to FIG. 2, the transmitter device 205 may generate two or more PSDUs 1005 in the MAC layer. As illustrated in FIG. 10, the transmitter device 205 may generate PSDU 1005-a and 1005-b. As such, the generated PSDUs 1005 may be encoded in the PHY layer. In some cases, the encoding process illustrated in multi-PSDU encoding procedure 1000 may be a case where each PSDU 1005 corresponds to a respective RU of an MRU and a respective MCS. In such cases, the transmitter device 205 may process each RU separately. While FIG. 10 illustrates two PSDUs 1005, it is understood that the transmitter device 205 may concurrently generate any quantity of PSDUs 1005 in the MAC layer. In some example, the process of FIG. 10 may be used for per RU MCS for OL OFDMA transmission with MRU, where, if each PSDU corresponds to one RU, then the quantity of PSDUs, RUs, and encoders are the same (e.g., N_psdu=Nru=N_encoder), and each RU is processed separately as shown in FIG. 10. To reduce the quantity of encoders (e.g., N_encoder), at least some RUs, MCSs, or both, with a same code rate may share one PSDU with joint encoding, where the coded bits may later be split by proportional RU parser to each shared RU.

Based on each PSDU 1005 corresponding to a respective RU, the transmitter device 205 may encode the bits of each PSDU 1005 in accordance with encoding procedure 1010. For example, the transmitter device 205 may perform a pre-FEC PHY padding (e.g., padding each PSDU 1005 with additional respective bits such that the quantity of bits for each PSDU 1005 satisfies a pre-FEC bit threshold). Based on performing the pre-FEC PHY padding, the transmitter device 205 may use a scramble for each PSDU 1005 (e.g., a device that transposes or inverts signals in the analog domain). Based on performing the scrambling, the transmitter device 205 may perform respective encoding on each PSDU 1005. For instance the respective encoding may correspond to the MCS associated with a given RU. While FIG. 10 illustrates the use of LDPC encoding, it is understood that the techniques of FIG. 10 may use other forms of encoding such as BCC, among other examples. Based on performing the encoding, the transmitter device 205 may perform post-FEC PHY padding for each PSDU 1005 (e.g., padding each PSDU 1005 with additional respective bits such that the quantity of bits for each PSDU 1005 satisfies a post-FEC bit threshold). In some examples the transmitter device 205 may encode the bits of each PSDU 1005 concurrently.

As illustrated in FIG. 10, each RU may be associated with a respective stream parser that may parse the encoded bits of the respective PSDU 1005 into subsets of bits corresponding to the spatial streams associated with the corresponding RU. As described with reference to FIG. 2, each of the spatial streams associated with a given RU may have a same MCS. Additionally, the quantity of bits in a given subset of bits may be proportional to the modulation size of the MCS corresponding to RU and the encoded bits may be parsed to each spatial stream via a round robin procedure. Additionally, each spatial stream may be associated with a respective constellation mapper. For instance, each constellation mapper may map the subset of bits parsed to the associated spatial stream into a respective constellation size associated with the corresponding MCS for the associated RU. As such, each constellation mapper may be based on the type of modulation for the corresponding MCS (e.g., QAM, QPSK, BPSK, among other examples). It is understood that each RU may be associated with any quantity of spatial streams corresponding to any quantity of constellation mappers.

Based on mapping the bits using the respective constellation mappers, the transmitter device 205 may perform tone mapping using respective tone mappers 1015 (tone mapper 1015-a, 1015-b, 1015-c, and 1015-d) associated with each spatial stream. In some examples, the transmitter device 205 may use a given tone mapper 1015 to permute the stream of constellation points to obtain the corresponding spatial stream. While FIG. 10 illustrates the use LDPC tone mappers, it is understood that the techniques of FIG. 10 may use other forms of interleaving such as BCC interleavers, among other examples. Additionally, the tone mappers 1015 may operate within each RU rather than within the MRU to separate given modulation schemes assigned to each RU of the MRU (e.g., to keep each QAM within its assigned RU).

Based on performing tone mapping, the transmitter device 205 may perform a PSDU finalization procedure 1020. For example, the transmitter device 205 may apply a respective CSD to one or more of the spatial streams. A CSD may be used to apply a cyclic delay to each of the spatial streams to increase the frequency diversity and reduce correlation between the transmission on each spatial steam.

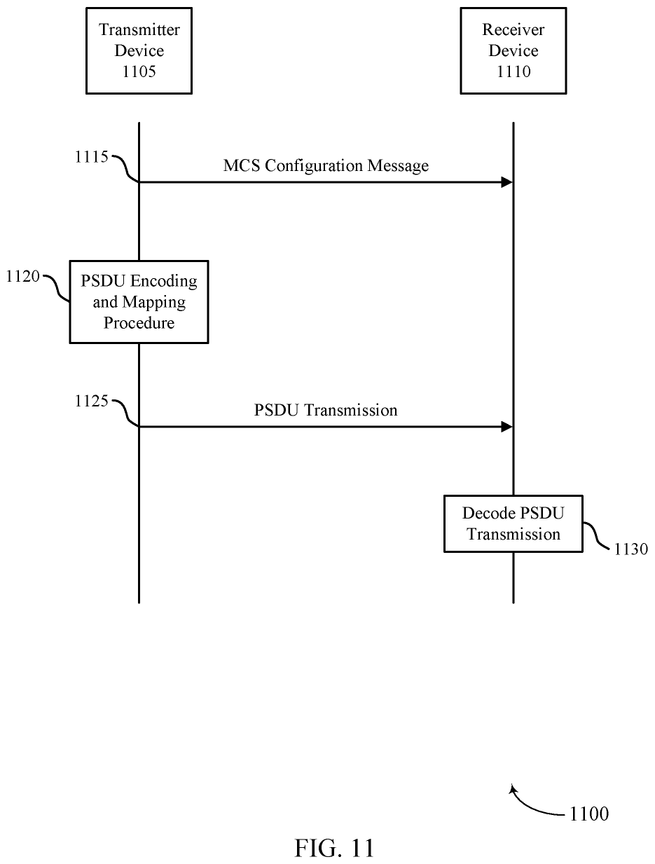

FIG. 11 shows an example of a process flow 1100 that supports signaling for multiple coding schemes to a single user device in accordance with one or more aspects of the present disclosure. In some examples, process flow 1100 may implement aspects of wireless communications system 100 and 200, single PSDU encoding procedure 300 through 700, and PSDU encoding procedure 800 through 1000. Process flow 1100 includes a transmitter device 1105 and a receiver device 1110, which may be respective examples of a transmitter device 205 and a receiver device 210, as described with reference to FIGS. 2 through 10. Alternative examples of the following may be implemented, where some steps are performed in a different order than described or are not performed at all. In some cases, steps may include additional features not mentioned below, or further steps may be added. In addition, while process flow 1100 shows processes between two devices, it should be understood that these processes may occur between any quantity of wireless devices and wireless device types.

At 1115, the transmitter device 1105 may transmit a MCS configuration message to receiver device 1110 (e.g., MCS configuration message 215, with reference to FIG. 2). For instance, the MCS configuration message may be an example of control signaling that indicates a set of different MCSs to be applied to at least one of a set of spatial streams, or a set of RUs, or both. Additionally, the control signaling may indicate that each respective MCS of the set of different MCSs may be applied to a respective spatial stream of the set of spatial streams or to a respective RU of the set of RUs. For example, the MCS configuration message may indicate the receiver device 1110, the MAC and PHY processes the transmitter device 1105 may use to generate and encode one or more PSDUs (e.g., one of the processes illustrated and described with reference to FIGS. 3 through 10).

In some examples, the control signaling may include a set of UIFs. For instance, each of the set of UIFs may indicate a respective MCS of the set of different MCSs may be applied to a respective spatial stream of the set of spatial streams or a respective RU of the set of RUs. Additionally or alternatively, each of the set of UIFs may include a user identification associated with the receiver device 1110.

In some examples, the control signaling includes a single USF that indicates the receiver device 1110. As such, the single USF may indicate each respective MCS of the set of different MCSs is being applied to a respective spatial stream of the set of spatial streams or to a respective RU of the set of RUs.

In some examples, the single USF may include a UIF of one or more bits. For instance, a first bit value of the one or more bits may indicate that the UIF includes a subfield indicating that a respective MCS of the set of different MCSs may be applied to each respective spatial stream of the set of spatial streams or each respective RU of the set of RUs. In cases where the one or more bits is of the first value, the quantity of bits in the subfield may correspond to a quantity of the set of spatial streams or a quantity of the set of RUs. For instance the set of spatial streams may divided into respective groups of spatial streams that each correspond to a respective MCS of the set of different MCSs or the set of RUs are divided into respective groups of RUs that each correspond to a respective MCS of the set of different MCSs. In such instances, the MCS configuration message may further indicate a size of each of the respective groups of spatial streams or a size of each of the respective groups of RUs, or a quantity of the respective groups of spatial streams or a quantity of the respective groups of RUs.

In some examples, the single USF has a fixed size.

In some cases, the MCS configuration message may indicate that each respective MCS corresponds to a respective spatial stream, each respective spatial stream is ordered in accordance with a non-increasing order of a respective code rate associated with the corresponding respective MCS, the single USF indicates a first MCS for a first spatial stream of the set of spatial streams and a respective differential value for each other spatial stream of the set of spatial streams. In such cases, each respective differential value may indicate an MCS relative to an MCS associated with an adjacent stream, and that the first MCS may be associated with a highest code rate or lowest code rate of the respective MCSs.

In some cases, the MCS configuration message may indicate that each respective MCS corresponds to a respective spatial stream, each spatial stream of the set of spatial streams are grouped into one or more spatial streams subsets, and that the single USF indicates a different MCS associated with each spatial stream subset of the one or more spatial stream subsets.

In some cases, the MCS configuration message may be an example of a PHY preamble that includes common field and set of UIFs. In some examples, the transmitter device 1105 may encode the common field and each UIF using a respective code block. In some other examples, the transmitter device 1105 may encode respective subsets of the set of UIFs using respective code blocks based on a quantity of bits in each respective UIF satisfying a bit quantity threshold, where a given subset of the set of UIFs may include a quantity of bits less than or equal to a size of a corresponding code block.

In some cases, the bit size of the MCS configuration message may be based on the MCS configuration message including the indication of the respective MCS per spatial stream of the set of spatial streams or per RU of the set of RUs.

At 1120, the transmitter device 1105 may encode one or more PSDUs in accordance with the PSDU encoding and mapping procedure (e.g., the PSDU encoding and mapping procedure 220, as described with reference to FIG. 2). The various implementations of the PSDU encoding and mapping procedure may correspond to FIGS. 3 through 10. As described herein, the MCS configuration message may indicate which PSDU encoding and mapping procedure the transmitter device 1105 may use to generate, encode, and map the one or more PSDUs.

In some examples, the transmitter device 1105 may perform the PSDU encoding and mapping procedure in accordance with single PSDU encoding procedure 300 (e.g., FIG. 3). For example, the transmitter device 1105 may encode a set of bits of a first PSDU using a same code rate. As such, the transmitter device 1105 may map, via a stream parser (e.g., proportional stream parser 310), one or more first bits to a first spatial stream and one or more second bits to a second spatial stream. In such examples, a first quantity of bits in the one or more first bits may be proportional to a first modulation size of a first MCS, and a second quantity of bits in the one or more second bits may be proportional to a second modulation size of a second MCS.

In some examples, the transmitter device 1105 may perform the PSDU encoding and mapping procedure in accordance with single PSDU encoding procedure 400 (e.g., FIG. 4). For example, the transmitter device 1105 may encode, using a set of encoders associated with the set of spatial streams, a set of bits of the first PSDU. As such, one or more first bits may be encoded using a first encoder of the set of encoders associated with the first spatial stream and one or more second bits may be encoded using a second encoder of the set of encoders associated with the second spatial stream. In such instances, a first quantity of bits in the one or more first bits may be proportional to a first modulation size and a first code rate of the first MCS, and a second quantity of bits in the one or more second bits may be proportional to a second modulation size and a second code rate of the second MCS. Additionally or alternatively, the process of single PSDU encoding procedure 400 may be modified in accordance with the process of single PSDU encoding procedure 500 (e.g., FIG. 5). In such cases, the MCSs of the set of different MCSs that have a same code rate may be associated with a same encoder of the set of encoders.

In some examples, the transmitter device 1105 may perform the PSDU encoding and mapping procedure in accordance with single PSDU encoding procedure 600 (e.g., FIG. 6). For example, the transmitter device 1105 may encode a set of bits of the first PSDU using a same code rate. As such, the transmitter device 1105 may map, via a RU parser (e.g., proportional RU parser 610), one or more first bits to the first RU and the one or more second bits to the second RU. In such instances, a first quantity of bits in the one or more first bits may be proportional to a first modulation size of the first MCS and a first size of the first RU, and a second quantity of bits in the one or more second bits may be proportional to a second modulation size of the second MCS a second size of the second RU. In some cases the first RU may be associated with a first tone mapper and the second RU may be associated with a second tone mapper.

In some examples, the transmitter device 1105 may perform the PSDU encoding and mapping procedure in accordance with single PSDU encoding procedure 700 (e.g., FIG. 7). For example, the transmitter device 1105 may encode, using a set of encoders associated with the set of RUs, a set of bits of the first PSDU. As such, one or more first bits may be encoded using a first encoder of the set of encoders associated with the first RU, and one or more second bits is encoded using a second encoder of the set of encoders associated with the second RU. In such instances, a first quantity of bits in the one or more first bits is proportional to a first modulation size, a first code rate of the first MCS, and a first size of the first RU and a second quantity of bits in the one or more second bits is proportional to a second modulation size, a second code rate of the second MCS, and a second size of the second RU. In some cases the first RU may be associated with a first tone mapper and the second RU may be associated with a second tone mapper.

In some examples, the transmitter device 1105 may perform the PSDU encoding and mapping procedure in accordance with multi-PSDU encoding procedure 800 (e.g., FIG. 8). For example, the transmitter device 1105 may generate multiple PSDUs in the MAC layer (e.g., a first PSDU and a second PSDU). As such, the transmitter device 1105 may encode the first PSDU using a first encoder of a set of encoders and the second PSDU using a second encoder of the set of encoders. In such instances, each of the set of encoders may be associated with a respective spatial stream of the set of spatial streams and the respective MCS associated with the respective spatial stream. Additionally or alternatively, the process of multi-PSDU encoding procedure 800 may be modified in accordance with the process of multi-PSDU encoding procedure 900 (e.g., FIG. 9). In such cases, the MCSs of the set of different MCSs that have a same code rate are associated with a same encoder of the set of encoders.

In some examples, the transmitter device 1105 may perform the PSDU encoding and mapping procedure in accordance with multi-PSDU encoding procedure 1000 (e.g., FIG. 10). For example, the transmitter device 1105 may generate multiple PSDUs in the MAC layer (e.g., a first PSDU and a second PSDU). As such, the transmitter device 1105 may encode the first PSDU using a first encoder of a set of encoders and the second PSDU using a second encoder of the set of encoders. In such instances, each of the set of encoders is associated with a respective RU of the set of RUs and the respective MCS may be associated with the respective RU. In some cases, each of respective RU is associated with a respective tone mapper.

At 1125, the transmitter device 1105 may transmit the one or more PSDUs prepared using the PSDU encoding and mapping procedure. For example, the transmitter device 1105 may transmit at least one or more first bits of a first PSDU to the receiver device 1110 via a first spatial stream of the set of spatial streams or via a first RU of the set of RUs using a first MCS of the set of different MCSs, and one or more second bits of the first PSDU or of a second PSDU, via a second spatial stream of the set of spatial streams or via a second RU of the set of RUs using a second MCS of the set of different MCSs, where the first MCS is different from the second MCS.

At 1130, the receiver device 1110 may receive the PSDU transmission and decode the one or more PSDUs using the information included in the MCS configuration message.

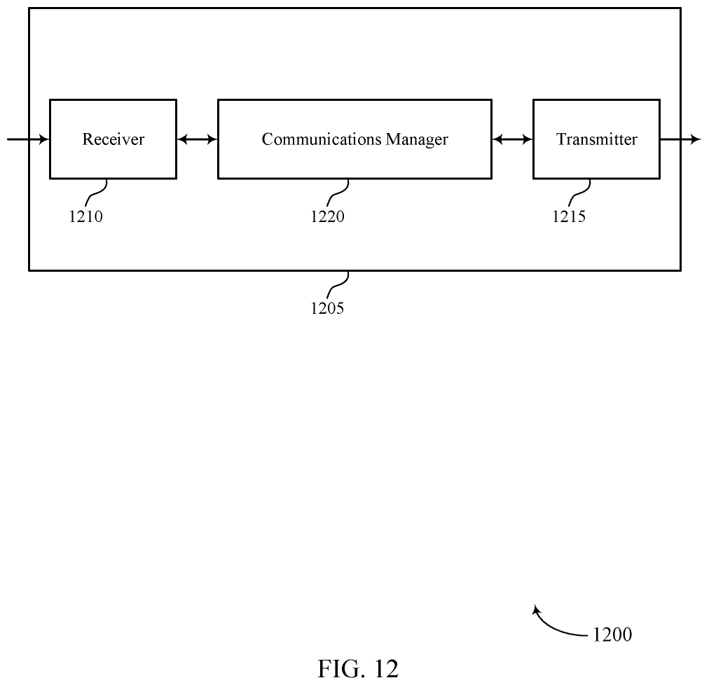

FIG. 12 shows a block diagram 1200 of a device 1205 that supports signaling for multiple coding schemes to a single user device in accordance with one or more aspects of the present disclosure. The device 1205 may be an example of aspects of an AP as described herein. The device 1205 may include a receiver 1210, a transmitter 1215, and a communications manager 1220. The device 1205 may also include at least one processor, which may be coupled with at least one memory, to support signaling of multiple coding schemes as discussed herein. Each of these components may be in communication with one another (e.g., via one or more buses).

The receiver 1210 may provide a means for receiving information such as packets, user data, control information, or any combination thereof associated with various information channels (e.g., control channels, data channels, information channels related to signaling support for multiple coding schemes to a single user device). Information may be passed on to other components of the device 1205. The receiver 1210 may utilize a single antenna or a set of multiple antennas.

The transmitter 1215 may provide a means for transmitting signals generated by other components of the device 1205. The transmitter 1215 may utilize a single antenna or a set of multiple antennas.

The communications manager 1220, the receiver 1210, the transmitter 1215, or various combinations thereof or various components thereof may be examples of means for performing various aspects of signaling support for multiple coding schemes to a single user device as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a transmitter wireless device in accordance with examples as disclosed herein. For example, the communications manager 1220 is capable of, configured to, or operable to support a means for transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs. The communications manager 1220 is capable of, configured to, or operable to support a means for transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs. The communications manager 1220 is capable of, configured to, or operable to support a means for transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for unequal MCSs across spatial streams or RUs which may result in reduced processing, reduced power consumption, or more efficient utilization of communication resources.

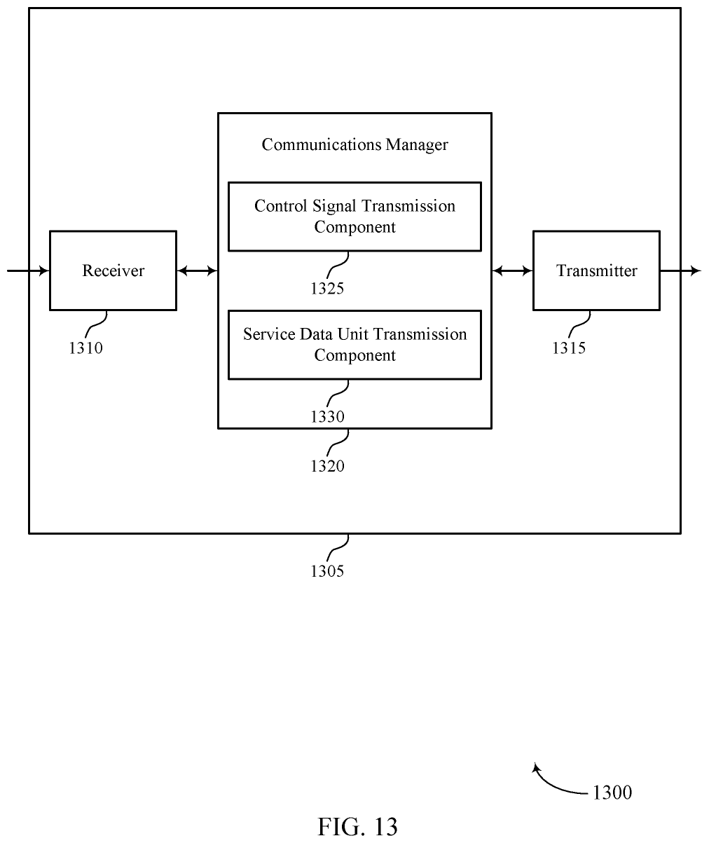

FIG. 13 shows a block diagram 1300 of a device 1305 that supports signaling for multiple coding schemes to a single user device in accordance with one or more aspects of the present disclosure. The device 1305 may be an example of aspects of a device 1205 or an AP 115 as described herein. The device 1305, or one or more components of the device 1305 (e.g., the receiver 1310, the transmitter 1315, the communications manager 1320), may also include at least one processor, which may be coupled with at least one memory, to support the techniques described herein. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to signaling support for multiple coding schemes to a single user device). Information may be passed on to other components of the device 1305. The receiver 1310 may utilize a single antenna or a set of multiple antennas.

The transmitter 1315 may provide a means for transmitting signals generated by other components of the device 1305. The transmitter 1315 may utilize a single antenna or a set of multiple antennas.

The device 1305, or various components thereof, may be an example of means for performing various aspects of signaling support for multiple coding schemes to a single user device as described herein. For example, the communications manager 1320 may include a control signal transmission component 1325 a service data unit transmission component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a transmitter wireless device in accordance with examples as disclosed herein. The control signal transmission component 1325 is capable of, configured to, or operable to support a means for transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs. The service data unit transmission component 1330 is capable of, configured to, or operable to support a means for transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs. The service data unit transmission component 1330 is capable of, configured to, or operable to support a means for transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

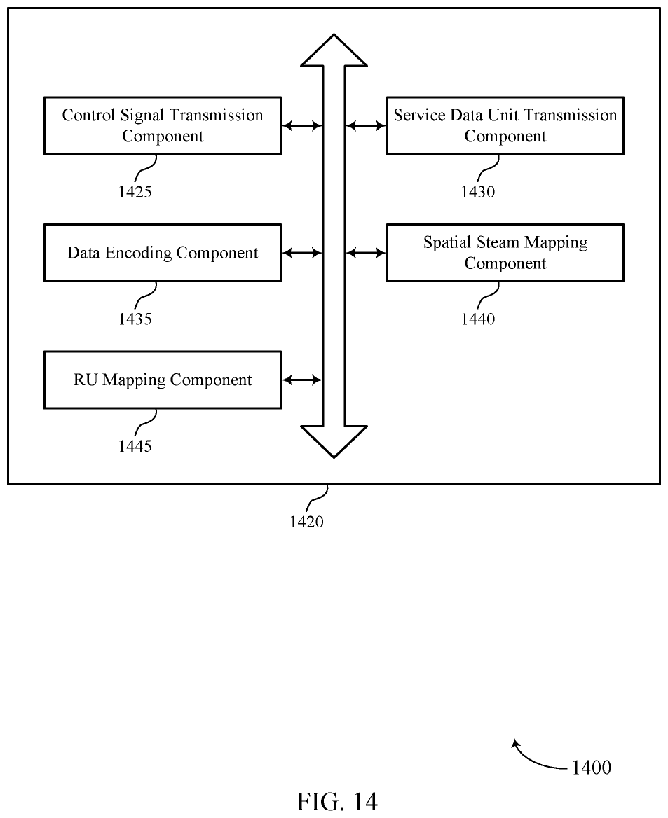

FIG. 14 shows a block diagram 1400 of a communications manager 1420 that supports signaling for multiple coding schemes to a single user device in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of signaling support for multiple coding schemes to a single user device as described herein. For example, the communications manager 1420 may include a control signal transmission component 1425, a service data unit transmission component 1430, a data encoding component 1435, a spatial steam mapping component 1440, a RU mapping component 1445, or any combination thereof. Each of these components, or sub-components thereof (e.g., at least one processor, at least one memory) may communicate, directly or indirectly, with one another (e.g., via one or more buses).

The communications manager 1420 may support wireless communications at a transmitter wireless device in accordance with examples as disclosed herein. The control signal transmission component 1425 is capable of, configured to, or operable to support a means for transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs. The service data unit transmission component 1430 is capable of, configured to, or operable to support a means for transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs. In some examples, the service data unit transmission component 1430 is capable of, configured to, or operable to support a means for transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

In some examples, the control signaling includes a set of multiple UIFs, each of the set of multiple UIFs indicates a respective MCS of the set of multiple different MCSs is being applied to a respective spatial stream of the set of multiple spatial streams or a respective RU of the set of multiple RUs, and each of the set of multiple UIFs includes a user identification associated with the first receiver wireless device.

In some examples, the control signaling includes a single USF that indicates the first receiver wireless device, the single USF indicating each respective MCS of the set of multiple different MCSs is being applied to a respective spatial stream of the set of multiple spatial streams or to a respective RU of the set of multiple RUs.

In some examples, the single USF includes a UIF including one or more bits, and a first bit value of the one or more bits indicates that the UIF includes a subfield indicating a respective MCS of the set of multiple different MCSs is being applied to each respective spatial stream of the set of multiple spatial streams or each respective RU of the set of multiple RUs.

In some examples, a size of each of the respective groups of spatial streams or a size of each of the respective groups of RUs. In some examples, a quantity of the respective groups of spatial streams or a quantity of the respective groups of RUs.

In some examples, the single USF has a fixed size.

In some examples, each respective MCS corresponds to a respective spatial stream, each respective spatial stream is ordered in accordance with a non-increasing order of a respective code rate associated with the corresponding respective MCS, the single USF indicates the first MCS for the first spatial stream of the set of multiple spatial streams and a respective differential value for each other spatial stream of the set of multiple spatial streams, each respective differential value indicates an MCS relative to an MCS associated with an adjacent stream, and the first MCS is associated with a highest code rate or lowest code rate of the respective MCSs.

In some examples, each respective MCS corresponds to a respective spatial stream, each spatial stream of the set of multiple spatial streams are grouped into one or more spatial streams subsets, and the single USF indicates a different MCS associated with each spatial stream subset of the one or more spatial stream subsets.

In some examples, the control signaling includes a common field and set of UIFs including the single USF, and the data encoding component 1435 is capable of, configured to, or operable to support a means for encoding the common field and each UIF using a respective code block.

In some examples, the control signaling includes a set of UIFs including the single USF, and the data encoding component 1435 is capable of, configured to, or operable to support a means for encoding respective subsets of the set of UIFs using respective code blocks based on a quantity of bits in each respective UIF satisfying a bit quantity threshold, where a given subset of the set of UIFs includes a quantity of bits less than or equal to a size of a corresponding code block.

In some examples, a bit size of the control signaling is based on the control signaling including the indication of the respective MCS per spatial stream of the set of multiple spatial streams or per RU of the set of multiple RUs.

In some examples, the data encoding component 1435 is capable of, configured to, or operable to support a means for encoding a set of bits of the first service data unit using a same code rate. In some examples, the spatial steam mapping component 1440 is capable of, configured to, or operable to support a means for mapping, via a stream parser, the one or more first bits to the first spatial stream and the one or more second bits to the second spatial stream, where a first quantity of bits in the one or more first bits is proportional to a first modulation size of the first MCS, and a second quantity of bits in the one or more second bits is proportional to a second modulation size of the second MCS.

In some examples, the data encoding component 1435 is capable of, configured to, or operable to support a means for encoding, using a set of multiple encoders associated with the set of multiple spatial streams, a set of bits of the first service data unit, where the one or more first bits is encoded using a first encoder of the set of multiple encoders associated with the first spatial stream, the one or more second bits is encoded using a second encoder of the set of multiple encoders associated with the second spatial stream, a first quantity of bits in the one or more first bits is proportional to a first modulation size and a first code rate of the first MCS, and a second quantity of bits in the one or more second bits is proportional to a second modulation size and a second code rate of the second MCS.

In some examples, MCSs of the set of multiple different MCSs that have a same code rate are associated with a same encoder of the set of multiple encoders.

In some examples, the data encoding component 1435 is capable of, configured to, or operable to support a means for encoding a set of bits of the first service data unit using a same code rate. In some examples, the RU mapping component 1445 is capable of, configured to, or operable to support a means for mapping, via a RU parser, the one or more first bits to the first RU and the one or more second bits to the second RU, where a first quantity of bits in the one or more first bits is proportional to a first modulation size of the first MCS and a first size of the first RU, the first RU associated with a first tone mapper, and a second quantity of bits in the one or more second bits is proportional to a second modulation size of the second MCS a second size of the second RU, the second RU associated with a second tone mapper.

In some examples, the data encoding component 1435 is capable of, configured to, or operable to support a means for encoding, using a set of multiple encoders associated with the set of multiple RUs, a set of bits of the first service data unit, where the one or more first bits is encoded using a first encoder of the set of multiple encoders associated with the first RU, the first RU associated with a first tone mapper, the one or more second bits is encoded using a second encoder of the set of multiple encoders associated with the second RU, the second RU associated with a second tone mapper, a first quantity of bits in the one or more first bits is proportional to a first modulation size, a first code rate of the first MCS, and a first size of the first RU, and a second quantity of bits in the one or more second bits is proportional to a second modulation size, a second code rate of the second MCS, and a second size of the second RU.

In some examples, the transmitter wireless device transmits the second service data unit in addition to the first service data unit, and the data encoding component 1435 is capable of, configured to, or operable to support a means for encoding the first service data unit using a first encoder of a set of multiple encoders and the second service data unit using a second encoder of the set of multiple encoders, where each of the set of multiple encoders is associated with a respective spatial stream of the set of multiple spatial streams and the respective MCS associated with the respective spatial stream.

In some examples, MCSs of the set of multiple different MCSs that have a same code rate are associated with a same encoder of the set of multiple encoders.

In some examples, the transmitter wireless device transmits the second service data unit in addition to the first service data unit, and the data encoding component 1435 is capable of, configured to, or operable to support a means for encoding the first service data unit using a first encoder of a set of multiple encoders and the second service data unit using a second encoder of the set of multiple encoders, where each of the set of multiple encoders is associated with a respective RU of the set of multiple RUs and the respective MCS associated with the respective RU, and each of respective RU is associated with a respective tone mapper.

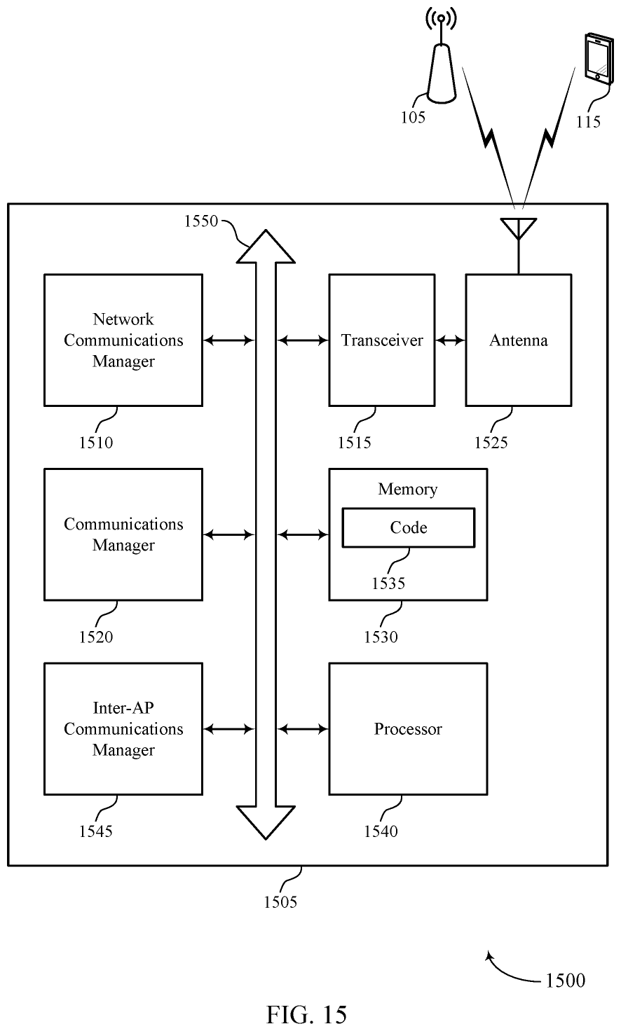

FIG. 15 shows a diagram of a system 1500 including a device 1505 that supports signaling for multiple coding schemes to a single user device in accordance with one or more aspects of the present disclosure. The device 1505 may be an example of or include the components of a device 1205, a device 1305, or an AP as described herein. The device 1505 may include components for bi-directional voice and data communications including components for transmitting and receiving communications, such as a communications manager 1520, a network communications manager 1510, a transceiver 1515, an antenna 1525, at least one memory 1530, code 1535, at least one processor 1540, and an inter-AP communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network (e.g., via one or more wired backhaul links). For example, the network communications manager 1510 may manage the transfer of data communications for client devices, such as one or more STAs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets and provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include RAM and ROM. The at least one memory 1530 may store computer-readable, computer-executable code 1535 including instructions that, when executed by the at least one processor 1540, cause the device 1505 to perform various functions described herein. In some cases, the at least one memory 1530 may contain, among other things, a BIOS which may control basic hardware or software operation such as the interaction with peripheral components or devices.

The at least one processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in at least one memory (e.g., the at least one memory 1530) to cause the device 1505 to perform various functions (e.g., functions or tasks supporting signaling support for multiple coding schemes to a single user device). For example, the device 1505 or a component of the device 1505 may include at least one processor 1540 and at least one memory 1530 coupled with or to the at least one processor 1540, the at least one processor 1540 and at least one memory 1530 configured to perform various functions described herein. In some examples, each processor of the one or more processors may be operable to perform or support a same set of operations, may be operable to perform or support a respective set of one or more operations, or a combination thereof. In some cases, each processor of the one or more processors may be capable of executing scripts or instructions of a respective set of one or more software programs stored in the device 1505. For example, at least one processor 1540 may include a first processor capable of executing scripts or instructions of one or more first software programs, a second processor capable of executing scripts or instructions of one or more second software programs, a third processor capable of executing scripts or instructions of one or more third software programs, and so on. Additionally, or alternatively, each processor of the one or more processors may be capable of executing scripts or instructions of each software program stored in the device 1505. In some examples, the at least one processor 1540 may include multiple processors, and the at least one memory 1530 may include multiple memories. One or more of the multiple processors may be coupled with one or more of the multiple memories, which may, individually or collectively, be configured to perform various functions herein.

The inter-station communications manager 1545 may manage communications with other APs 105, and may include a controller or scheduler for controlling communications with STAs 115 in cooperation with other APs 105. For example, the inter-station communications manager 1545 may coordinate scheduling for transmissions to APs 105 for various interference mitigation techniques such as beamforming or joint transmission. In some examples, the inter-station communications manager 1545 may provide an X2 interface within an LTE/LTE-A wireless communication network technology to provide communication between APs 105.

The communications manager 1520 may support wireless communications at a transmitter wireless device in accordance with examples as disclosed herein. For example, the communications manager 1520 is capable of, configured to, or operable to support a means for transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs. The communications manager 1520 is capable of, configured to, or operable to support a means for transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs. The communications manager 1520 is capable of, configured to, or operable to support a means for transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS.

By including or configuring the communications manager 1520 in accordance with examples as described herein, the device 1505 may support techniques for unequal MCSs across spatial streams or RUs which may result in improved communication reliability, reduced latency, improved user experience related to reduced processing, reduced power consumption, more efficient utilization of communication resources, improved coordination between devices, longer battery life, improved utilization of processing capability.

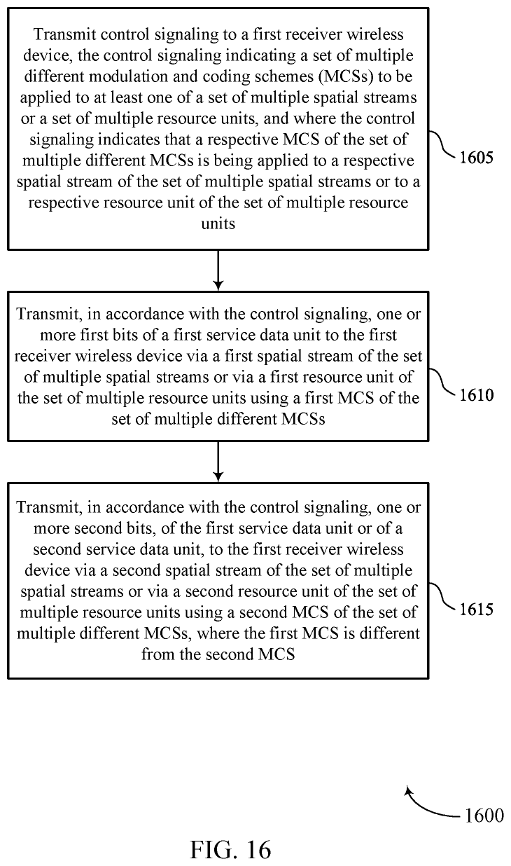

FIG. 16 shows a flowchart illustrating a method 1600 that supports signaling for multiple coding schemes to a single user device in accordance with aspects of the present disclosure. The operations of the method 1600 may be implemented by an AP or its components as described herein. For example, the operations of the method 1600 may be performed by an AP as described with reference to FIGS. 1 through 15. In some examples, an AP may execute a set of instructions to control the functional elements of the wireless AP to perform the described functions. Additionally, or alternatively, the wireless AP may perform aspects of the described functions using special-purpose hardware.

At 1605, the method may include transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs. The operations of block 1605 may be performed in accordance with examples as disclosed herein. In some examples, aspects of the operations of 1605 may be performed by a control signal transmission component 1425 as described with reference to FIG. 14.

At 1610, the method may include transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs. The operations of block 1610 may be performed in accordance with examples as disclosed herein. In some examples, aspects of the operations of 1610 may be performed by a service data unit transmission component 1430 as described with reference to FIG. 14.

At 1615, the method may include transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS. The operations of block 1615 may be performed in accordance with examples as disclosed herein. In some examples, aspects of the operations of 1615 may be performed by a service data unit transmission component 1430 as described with reference to FIG. 14.

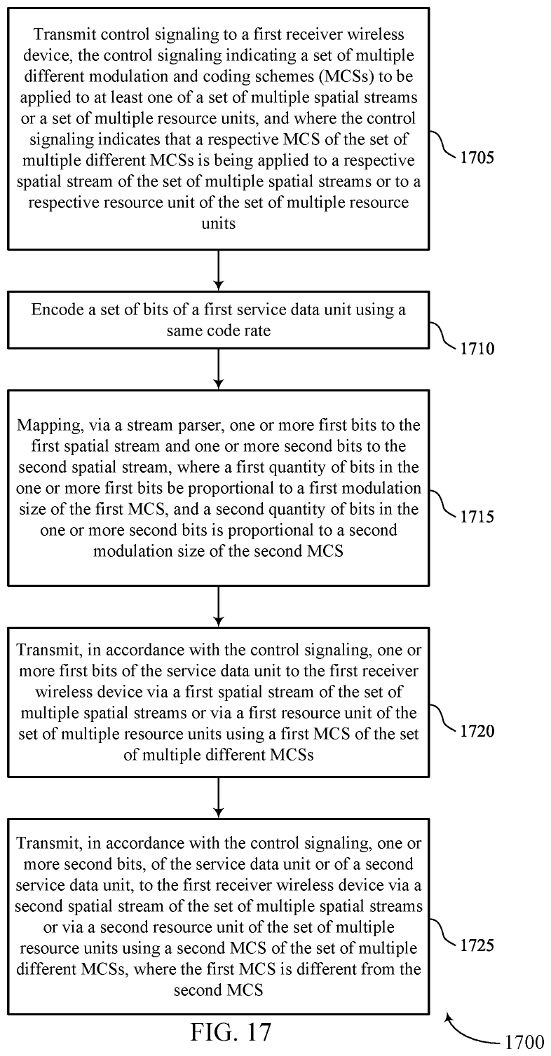

FIG. 17 shows a flowchart illustrating a method 1700 that supports signaling for multiple coding schemes to a single user device in accordance with aspects of the present disclosure. The operations of the method 1700 may be implemented by an AP or its components as described herein. For example, the operations of the method 1700 may be performed by an AP as described with reference to FIGS. 1 through 15. In some examples, an AP may execute a set of instructions to control the functional elements of the wireless AP to perform the described functions. Additionally, or alternatively, the wireless AP may perform aspects of the described functions using special-purpose hardware.

At 1705, the method may include transmitting control signaling to a first receiver wireless device, the control signaling indicating a set of multiple different modulation and coding schemes (MCSs) to be applied to at least one of a set of multiple spatial streams or a set of multiple RUs, and where the control signaling indicates that a respective MCS of the set of multiple different MCSs is being applied to a respective spatial stream of the set of multiple spatial streams or to a respective RU of the set of multiple RUs. The operations of block 1705 may be performed in accordance with examples as disclosed herein. In some examples, aspects of the operations of 1705 may be performed by a control signal transmission component 1425 as described with reference to FIG. 14.

At 1710, the method may include encoding a set of bits of the first service data unit using a same code rate. The operations of block 1710 may be performed in accordance with examples as disclosed herein. In some examples, aspects of the operations of 1710 may be performed by a data encoding component 1435 as described with reference to FIG. 14.

At 1715, the method may include mapping, via a stream parser, the one or more first bits to the first spatial stream and the one or more second bits to the second spatial stream, where a first quantity of bits in the one or more first bits is proportional to a first modulation size of the first MCS, and a second quantity of bits in the one or more second bits is proportional to a second modulation size of the second MCS. The operations of block 1715 may be performed in accordance with examples as disclosed herein. In some examples, aspects of the operations of 1715 may be performed by a spatial steam mapping component 1440 as described with reference to FIG. 14.

At 1720, the method may include transmitting, in accordance with the control signaling, one or more first bits of a first service data unit to the first receiver wireless device via a first spatial stream of the set of multiple spatial streams or via a first RU of the set of multiple RUs using a first MCS of the set of multiple different MCSs. The operations of block 1720 may be performed in accordance with examples as disclosed herein. In some examples, aspects of the operations of 1720 may be performed by a service data unit transmission component 1430 as described with reference to FIG. 14.

At 1725, the method may include transmitting, in accordance with the control signaling, one or more second bits, of the first service data unit or of a second service data unit, to the first receiver wireless device via a second spatial stream of the set of multiple spatial streams or via a second RU of the set of multiple RUs using a second MCS of the set of multiple different MCSs, where the first MCS is different from the second MCS. The operations of block 1725 may be performed in accordance with examples as disclosed herein. In some examples, aspects of the operations of 1725 may be performed by a service data unit transmission component 1430 as described with reference to FIG. 14.

It should be noted that the methods described herein describe possible implementations, and that the operations and the steps may be rearranged or otherwise modified and that other implementations are possible. Furthermore, aspects from two or more of the methods may be combined.

The following provides an overview of aspects of the present disclosure:

Aspect 1: A method for wireless communications at a transmitter wireless device, comprising: transmitting control signaling to a first receiver wireless device, the control signaling indicating a plurality of different modulation and coding schemes (MCSs) to be applied to at least one of a plurality of spatial streams or a plurality of RUs, and wherein the control signaling indicates that a respective MCS of the plurality of different MCSs is being applied to a respective spatial stream of the plurality of spatial streams or to a respective RU of the plurality of RUs; transmitting, in accordance with the control signaling, one or more first bits of a first service data unit to the first receiver wireless device via a first spatial stream of the plurality of spatial streams or via a first RU of the plurality of RUs using a first MCS of the plurality of different MCSs; and transmitting, in accordance with the control signaling, one or more second bits, of the first service data unit or of a second service data unit, to the first receiver wireless device via a second spatial stream of the plurality of spatial streams or via a second RU of the plurality of RUs using a second MCS of the plurality of different MCSs, wherein the first MCS is different from the second MCS.

Aspect 2: The method of aspect 1, wherein the control signaling comprises a plurality of UIFs, each of the plurality of UIFs indicates a respective MCS of the plurality of different MCSs is being applied to a respective spatial stream of the plurality of spatial streams or a respective RU of the plurality of RUs, and each of the plurality of UIFs comprises a user identification associated with the first receiver wireless device.

Aspect 3: The method of any of aspects 1 through 2, wherein the control signaling comprises a single USF that indicates the first receiver wireless device, the single USF indicating each respective MCS of the plurality of different MCSs is being applied to a respective spatial stream of the plurality of spatial streams or to a respective RU of the plurality of RUs.

Aspect 4: The method of aspect 3, wherein the single USF comprises a UIF comprising one or more bits, and a first bit value of the one or more bits indicates that the UIF comprises a subfield indicating a respective MCS of the plurality of different MCSs is being applied to each respective spatial stream of the plurality of spatial streams or each respective RU of the plurality of RUs.

Aspect 5: The method of aspect 4, wherein a quantity of bits in the subfield corresponds to a quantity of the plurality of spatial streams or a quantity of the plurality of RUs, wherein the plurality of spatial streams are divided into respective groups of spatial streams that each correspond to a respective MCS of the plurality of different MCSs or the plurality of RUs are divided into respective groups of RUs that each correspond to a respective MCS of the plurality of different MCSs, the control signaling further indicating a size of each of the respective groups of spatial streams or a size of each of the respective groups of RUs, or a quantity of the respective groups of spatial streams or a quantity of the respective groups of RUs.

Aspect 6: The method of any of aspects 3 through 5, wherein the single USF has a fixed size.

Aspect 7: The method of any of aspects 3 through 6, wherein each respective MCS corresponds to a respective spatial stream, each respective spatial stream is ordered in accordance with a non-increasing order of a respective code rate associated with the corresponding respective MCS, the single USF indicates the first MCS for the first spatial stream of the plurality of spatial streams and a respective differential value for each other spatial stream of the plurality of spatial streams, each respective differential value indicates an MCS relative to an MCS associated with an adjacent stream, and the first MCS is associated with a highest code rate or lowest code rate of the respective MCSs.

Aspect 8: The method of any of aspects 3 through 7, wherein each respective MCS corresponds to a respective spatial stream, each spatial stream of the plurality of spatial streams are grouped into one or more spatial streams subsets, and the single USF indicates a different MCS associated with each spatial stream subset of the one or more spatial stream subsets.

Aspect 9: The method of any of aspects 3 through 8, wherein the control signaling comprises a common field and set of UIFs including the single USF, the method further comprising: encoding the common field and each UIF using a respective code block.

Aspect 10: The method of any of aspects 3 through 9, wherein the control signaling comprises a set of UIFs including the single USF, the method further comprising: encoding respective subsets of the set of UIFs using respective code blocks based at least in part on a quantity of bits in each respective UIF satisfying a bit quantity threshold, wherein a given subset of the set of UIFs comprises a quantity of bits less than or equal to a size of a corresponding code block.

Aspect 11: The method of any of aspects 3 through 10, wherein a bit size of the control signaling is based at least in part on the control signaling comprising the indication of the respective MCS per spatial stream of the plurality of spatial streams or per RU of the plurality of RUs.

Aspect 12: The method of any of aspects 1 through 11, further comprising: encoding a set of bits of the first service data unit using a same code rate; and mapping, via a stream parser, the one or more first bits to the first spatial stream and the one or more second bits to the second spatial stream, wherein a first quantity of bits in the one or more first bits is proportional to a first modulation size of the first MCS, and a second quantity of bits in the one or more second bits is proportional to a second modulation size of the second MCS.

Aspect 13: The method of any of aspects 1 through 12, further comprising: encoding, using a plurality of encoders associated with the plurality of spatial streams, a set of bits of the first service data unit, wherein the one or more first bits is encoded using a first encoder of the plurality of encoders associated with the first spatial stream, the one or more second bits is encoded using a second encoder of the plurality of encoders associated with the second spatial stream, a first quantity of bits in the one or more first bits is proportional to a first modulation size and a first code rate of the first MCS, and a second quantity of bits in the one or more second bits is proportional to a second modulation size and a second code rate of the second MCS.

Aspect 14: The method of aspect 13, wherein MCSs of the plurality of different MCSs that have a same code rate are associated with a same encoder of the plurality of encoders.

Aspect 15: The method of any of aspects 1 through 14, further comprising: encoding a set of bits of the first service data unit using a same code rate; and mapping, via a RU parser, the one or more first bits to the first RU and the one or more second bits to the second RU, wherein a first quantity of bits in the one or more first bits is proportional to a first modulation size of the first MCS and a first size of the first RU, the first RU associated with a first tone mapper, and a second quantity of bits in the one or more second bits is proportional to a second modulation size of the second MCS a second size of the second RU, the second RU associated with a second tone mapper.

Aspect 16: The method of any of aspects 1 through 15, further comprising: encoding, using a plurality of encoders associated with the plurality of RUs, a set of bits of the first service data unit, wherein the one or more first bits is encoded using a first encoder of the plurality of encoders associated with the first RU, the first RU associated with a first tone mapper, the one or more second bits is encoded using a second encoder of the plurality of encoders associated with the second RU, the second RU associated with a second tone mapper, a first quantity of bits in the one or more first bits is proportional to a first modulation size, a first code rate of the first MCS, and a first size of the first RU, and a second quantity of bits in the one or more second bits is proportional to a second modulation size, a second code rate of the second MCS, and a second size of the second RU.

Aspect 17: The method of any of aspects 1 through 16, wherein the transmitter wireless device transmits the second service data unit in addition to the first service data unit, the method further comprising: encoding the first service data unit using a first encoder of a plurality of encoders and the second service data unit using a second encoder of the plurality of encoders, wherein each of the plurality of encoders is associated with a respective spatial stream of the plurality of spatial streams and the respective MCS associated with the respective spatial stream.

Aspect 18: The method of aspect 17, wherein MCSs of the plurality of different MCSs that have a same code rate are associated with a same encoder of the plurality of encoders.

Aspect 19: The method of any of aspects 1 through 18, wherein the transmitter wireless device transmits the second service data unit in addition to the first service data unit, the method further comprising: encoding the first service data unit using a first encoder of a plurality of encoders and the second service data unit using a second encoder of the plurality of encoders, wherein each of the plurality of encoders is associated with a respective RU of the plurality of RUs and the respective MCS associated with the respective RU, and each of respective RU is associated with a respective tone mapper.

Aspect 20: An apparatus for wireless communications at a transmitter wireless device, comprising at least one memory and at least one processor coupled to the at least one memory, the at least one processor configured to perform a method of any of aspects 1 through 19.

Aspect 21: An apparatus for wireless communications at a transmitter wireless device, comprising at least one means for performing a method of any of aspects 1 through 19.

Aspect 22: A non-transitory computer-readable medium storing code for wireless communications at a transmitter wireless device, the code comprising instructions executable by at least one processor to perform a method of any of aspects 1 through 19.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein-including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). In some examples, a processor may be implemented as multiple processors, where each processor of the multiple processors may be operable perform a common set of operations, a respective set of one or more operations, or a combination thereof. For example, to perform a first operation and a second operation, a first processor may be operable perform the first operation and the second processor may be operable to perform the second operation, or the first processor may be operable to perform either of the first operation or the second operation and the second processor may be operable to perform either of the first operation or the second operation.

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

The functions described herein may be implemented in hardware, software executed by at least one processor, firmware, or any combination thereof. If implemented in software executed by at least one processor, the functions may be stored on or transmitted over as one or more instructions or code on a computer-readable medium. Other examples and implementations are within the scope of the disclosure and appended claims. For example, due to the nature of software, functions described herein may be implemented using software executed by at least one processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Any functions or operations described herein as being capable of being performed by at least one memory may be performed by multiple memories that, individually or collectively, are capable of performing the described functions or operations. For example, the functions described herein may be performed by multiple memories, each tasked with at least a subset of the described functions, such that, collectively, the multiple memories perform all of the described functions. As such, the described functions can be performed by a single memory or a group of memories functioning together (i.e., collectively) to perform the described functions, where any one memory performs at least a subset of the described functions.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

What is claimed is:

1. An apparatus for wireless communications at a transmitter wireless device, comprising:
at least one memory; and
at least one processor coupled to the at least one memory, the at least one processor configured to:
transmit control signaling to a first receiver wireless device, the control signaling indicating a plurality of different modulation and coding schemes (MCSs) to be applied to at least one of a plurality of spatial streams or a plurality of resource units, and wherein the control signaling indicates that a respective MCS of the plurality of different MCSs is being applied to a respective spatial stream of the plurality of spatial streams or to a respective resource unit of the plurality of resource units;
transmit, in accordance with the control signaling, one or more first bits of a first service data unit to the first receiver wireless device via a first spatial stream of the plurality of spatial streams or via a first resource unit of the plurality of resource units using a first MCS of the plurality of different MCSs; and
transmit, in accordance with the control signaling, one or more second bits, of the first service data unit or of a second service data unit, to the first receiver wireless device via a second spatial stream of the plurality of spatial streams or via a second resource unit of the plurality of resource units using a second MCS of the plurality of different MCSs, wherein the first MCS is different from the second MCS.

2. The apparatus of claim 1, wherein:
the control signaling comprises a plurality of user information fields,
each of the plurality of user information fields indicates a respective MCS of the plurality of different MCSs is being applied to a respective spatial stream of the plurality of spatial streams or a respective resource unit of the plurality of resource units, and
each of the plurality of user information fields comprises a user identification associated with the first receiver wireless device.

3. The apparatus of claim 1, wherein the control signaling comprises a single user specific field that indicates the first receiver wireless device, the single user specific field indicating each respective MCS of the plurality of different MCSs is being applied to a respective spatial stream of the plurality of spatial streams or to a respective resource unit of the plurality of resource units.

4. The apparatus of claim 3, wherein:
the single user specific field comprises a user information field comprising one or more bits, and
a first bit value of the one or more bits indicates that the user information field comprises a subfield indicating a respective MCS of the plurality of different MCSs is being applied to each respective spatial stream of the plurality of spatial streams or each respective resource unit of the plurality of resource units.

5. The apparatus of claim 4, wherein a quantity of bits in the subfield corresponds to a quantity of the plurality of spatial streams or a quantity of the plurality of resource units, wherein the plurality of spatial streams are divided into respective groups of spatial streams that each correspond to a respective MCS of the plurality of different MCSs or the plurality of resource units are divided into respective groups of resource units that each correspond to a respective MCS of the plurality of different MCSs, the control signaling further indicating:
a size of each of the respective groups of spatial streams or a size of each of the respective groups of resource units, or
a quantity of the respective groups of spatial streams or a quantity of the respective groups of resource units.

6. The apparatus of claim 3, wherein the single user specific field has a fixed size.

7. The apparatus of claim 3, wherein:
each respective MCS corresponds to a respective spatial stream,
each respective spatial stream is ordered in accordance with a non-increasing order of a respective code rate associated with the corresponding respective MCS,
the single user specific field indicates the first MCS for the first spatial stream of the plurality of spatial streams and a respective differential value for each other spatial stream of the plurality of spatial streams,
each respective differential value indicates an MCS relative to an MCS associated with an adjacent stream, and
the first MCS is associated with a highest code rate or lowest code rate of the respective MCSs.

8. The apparatus of claim 3, wherein:
each respective MCS corresponds to a respective spatial stream,
each spatial stream of the plurality of spatial streams are grouped into one or more spatial streams subsets, and
the single user specific field indicates a different MCS associated with each spatial stream subset of the one or more spatial stream subsets.

9. The apparatus of claim 3, wherein the control signaling comprises a common field and set of user information fields including the single user specific field, and the at least one processor is configured to:
encode the common field and each user information field using a respective code block.

10. The apparatus of claim 3, wherein the control signaling comprises a set of user information fields including the single user specific field, and the at least one processor is configured to:
encode respective subsets of the set of user information fields using respective code blocks based at least in part on a quantity of bits in each respective user information field satisfying a bit quantity threshold, wherein a given subset of the set of user information fields comprises a quantity of bits less than or equal to a size of a corresponding code block.

11. The apparatus of claim 3, wherein a bit size of the control signaling is based at least in part on the control signaling comprising the indication of the respective MCS per spatial stream of the plurality of spatial streams or per resource unit of the plurality of resource units.

12. The apparatus of claim 1, wherein the at least one processor is configured to:
encode a set of bits of the first service data unit using a same code rate; and
map, via a stream parser, the one or more first bits to the first spatial stream and the one or more second bits to the second spatial stream, wherein:
a first quantity of bits in the one or more first bits be proportional to a first modulation size of the first MCS, and
a second quantity of bits in the one or more second bits is proportional to a second modulation size of the second MCS.

13. The apparatus of claim 1, wherein the at least one processor is configured to:
encode, using a plurality of encoders associated with the plurality of spatial streams, a set of bits of the first service data unit, wherein:
the one or more first bits is encoded using a first encoder of the plurality of encoders associated with the first spatial stream,
the one or more second bits is encoded using a second encoder of the plurality of encoders associated with the second spatial stream,
a first quantity of bits in the one or more first bits is proportional to a first modulation size and a first code rate of the first MCS, and
a second quantity of bits in the one or more second bits is proportional to a second modulation size and a second code rate of the second MCS.

14. The apparatus of claim 13, wherein MCSs of the plurality of different MCSs that have a same code rate are associated with a same encoder of the plurality of encoders.

15. The apparatus of claim 1, wherein the at least one processor is configured to:
encode a set of bits of the first service data unit using a same code rate; and
map, via a resource unit parser, the one or more first bits to the first resource unit and the one or more second bits to the second resource unit, wherein:
a first quantity of bits in the one or more first bits be proportional to a first modulation size of the first MCS and a first size of the first resource unit, the first resource unit associated with a first tone mapper, and
a second quantity of bits in the one or more second bits is proportional to a second modulation size of the second MCS a second size of the second resource unit, the second resource unit associated with a second tone mapper.

16. The apparatus of claim 1, wherein the at least one processor is configured to:
encode, using a plurality of encoders associated with the plurality of resource units, a set of bits of the first service data unit, wherein:
the one or more first bits is encoded using a first encoder of the plurality of encoders associated with the first resource unit, the first resource unit associated with a first tone mapper,
the one or more second bits is encoded using a second encoder of the plurality of encoders associated with the second resource unit, the second resource unit associated with a second tone mapper,
a first quantity of bits in the one or more first bits is proportional to a first modulation size, a first code rate of the first MCS, and a first size of the first resource unit, and
a second quantity of bits in the one or more second bits is proportional to a second modulation size, a second code rate of the second MCS, and a second size of the second resource unit.

17. The apparatus of claim 1, wherein the transmitter wireless device transmits the second service data unit in addition to the first service data unit, and the at least one processor is configured to:
encode the first service data unit using a first encoder of a plurality of encoders and the second service data unit using a second encoder of the plurality of encoders, wherein each of the plurality of encoders is associated with a respective spatial stream of the plurality of spatial streams and the respective MCS associated with the respective spatial stream.

18. The apparatus of claim 17, wherein MCSs of the plurality of different MCSs that have a same code rate are associated with a same encoder of the plurality of encoders.

19. The apparatus of claim 1, wherein the transmitter wireless device transmits the second service data unit in addition to the first service data unit, the at least one processor is configured to:
encode the first service data unit using a first encoder of a plurality of encoders and the second service data unit using a second encoder of the plurality of encoders, wherein:
each of the plurality of encoders is associated with a respective resource unit of the plurality of resource units and the respective MCS associated with the respective resource unit, and
each of respective resource unit is associated with a respective tone mapper.

20. A method for wireless communications at a transmitter wireless device, comprising:
transmitting control signaling to a first receiver wireless device, the control signaling indicating a plurality of different modulation and coding schemes (MCSs) to be applied to at least one of a plurality of spatial streams or a plurality of resource units, and wherein the control signaling indicates that a respective MCS of the plurality of different MCSs is being applied to a respective spatial stream of the plurality of spatial streams or to a respective resource unit of the plurality of resource units;
transmitting, in accordance with the control signaling, one or more first bits of a first service data unit to the first receiver wireless device via a first spatial stream of the plurality of spatial streams or via a first resource unit of the plurality of resource units using a first MCS of the plurality of different MCSs; and
transmitting, in accordance with the control signaling, one or more second bits, of the first service data unit or of a second service data unit, to the first receiver wireless device via a second spatial stream of the plurality of spatial streams or via a second resource unit of the plurality of resource units using a second MCS of the plurality of different MCSs, wherein the first MCS is different from the second MCS.

21. The method of claim 20, wherein:
the control signaling comprises a plurality of user information fields,
each of the plurality of user information fields indicates a respective MCS of the plurality of different MCSs is being applied to a respective spatial stream of the plurality of spatial streams or a respective resource unit of the plurality of resource units, and
each of the plurality of user information fields comprises a user identification associated with the first receiver wireless device.

22. The method of claim 20, wherein the control signaling comprises a single user specific field that indicates the first receiver wireless device, the single user specific field indicating each respective MCS of the plurality of different MCSs is being applied to a respective spatial stream of the plurality of spatial streams or to a respective resource unit of the plurality of resource units.

23. The method of claim 22, wherein:
the single user specific field comprises a user information field comprising one or more bits, and
a first bit value of the one or more bits indicates that the user information field comprises a subfield indicating a respective MCS of the plurality of different MCSs is being applied to each respective spatial stream of the plurality of spatial streams or each respective resource unit of the plurality of resource units.

24. The method of claim 23, wherein a quantity of bits in the subfield corresponds to a quantity of the plurality of spatial streams or a quantity of the plurality of resource units, wherein the plurality of spatial streams are divided into respective groups of spatial streams that each correspond to a respective MCS of the plurality of different MCSs or the plurality of resource units are divided into respective groups of resource units that each correspond to a respective MCS of the plurality of different MCSs, the control signaling further indicating:
a size of each of the respective groups of spatial streams or a size of each of the respective groups of resource units, or
a quantity of the respective groups of spatial streams or a quantity of the respective groups of resource units.

25. The method of claim 22, wherein the single user specific field has a fixed size.

26. The method of claim 22, wherein:
each respective MCS corresponds to a respective spatial stream,
each respective spatial stream is ordered in accordance with a non-increasing order of a respective code rate associated with the corresponding respective MCS,
the single user specific field indicates the first MCS for the first spatial stream of the plurality of spatial streams and a respective differential value for each other spatial stream of the plurality of spatial streams,
each respective differential value indicates an MCS relative to an MCS associated with an adjacent stream, and
the first MCS is associated with a highest code rate or lowest code rate of the respective MCSs.

27. The method of claim 22, wherein:
each respective MCS corresponds to a respective spatial stream,
each spatial stream of the plurality of spatial streams are grouped into one or more spatial streams subsets, and
the single user specific field indicates a different MCS associated with each spatial stream subset of the one or more spatial stream subsets.

28. The method of claim 22, wherein the control signaling comprises a common field and set of user information fields including the single user specific field, the method further comprising:
encoding the common field and each user information field using a respective code block.

29. An apparatus for wireless communications at a transmitter wireless device, comprising:
means for transmitting control signaling to a first receiver wireless device, the control signaling indicating a plurality of different modulation and coding schemes (MCSs) to be applied to at least one of a plurality of spatial streams or a plurality of resource units, and wherein the control signaling indicates that a respective MCS of the plurality of different MCSs is being applied to a respective spatial stream of the plurality of spatial streams or to a respective resource unit of the plurality of resource units;
means for transmitting, in accordance with the control signaling, one or more first bits of a first service data unit to the first receiver wireless device via a first spatial stream of the plurality of spatial streams or via a first resource unit of the plurality of resource units using a first MCS of the plurality of different MCSs; and
means for transmitting, in accordance with the control signaling, one or more second bits, of the first service data unit or of a second service data unit, to the first receiver wireless device via a second spatial stream of the plurality of spatial streams or via a second resource unit of the plurality of resource units using a second MCS of the plurality of different MCSs, wherein the first MCS is different from the second MCS.

30. A non-transitory computer-readable medium storing code for wireless communications at a transmitter wireless device, the code comprising instructions executable by at least one processor to:
transmit control signaling to a first receiver wireless device, the control signaling indicating a plurality of different modulation and coding schemes (MCSs) to be applied to at least one of a plurality of spatial streams or a plurality of resource units, and wherein the control signaling indicates that a respective MCS of the plurality of different MCSs is being applied to a respective spatial stream of the plurality of spatial streams or to a respective resource unit of the plurality of resource units;
transmit, in accordance with the control signaling, one or more first bits of a first service data unit to the first receiver wireless device via a first spatial stream of the plurality of spatial streams or via a first resource unit of the plurality of resource units using a first MCS of the plurality of different MCSs; and
transmit, in accordance with the control signaling, one or more second bits, of the first service data unit or of a second service data unit, to the first receiver wireless device via a second spatial stream of the plurality of spatial streams or via a second resource unit of the plurality of resource units using a second MCS of the plurality of different MCSs, wherein the first MCS is different from the second MCS.
